(19) United States
(12) Patent Application Publication
(10) Pub. No.: US 2014/0192886 A1
(43) Pub. Date: Jul. 10, 2014

(54) Method and Apparatus for Encoding an Image Into a Video Bitstream and Decoding Corresponding Video Bitstream Using Enhanced Inter Layer Residual Prediction

(71) Applicant: Canon Kabushiki Kaisha, Tokyo (JP)

(72) Inventors: Edouard FRANÇOIS, BOURG DES COMPTES (FR); Christophe GISQUET, RENNES (FR); Patrice ONNO, RENNES (FR); Guillaume LAROCHE, MELESSE (FR)

(73) Assignee: CANON KABUSHIKI KAISHA, Tokyo (JP)

(21) Appl. No.: 14/147,380

(22) Filed: Jan. 3, 2014

(30) Foreign Application Priority Data
Jan. 4, 2013 (GB) 1300145.8
Jan. 7, 2013 (GB) 1300226.6

(51) Int. Cl. H04N 19/51

(52) U.S. Cl. CPC H04N 19/00684
USPC 375/240.16

(57) ABSTRACT

A method for encoding an image of pixels and for decoding a corresponding bit stream is described. More particularly, it concerns residual prediction according to a spatial scalable encoding scheme. It can be considered in the context of the Scalable extension of the HEVC standard (noted SHVC), being developed by the ISO-MPEG and ITU-T standardization organizations. It is proposed to simplify the computational complexity and the memory usage needed by the GRILP and DIFF inter modes by combining upsampling and motion compensation operations into one single operation and/or reducing the complexity of the linear filtering processes involved in some of the processes and/or adopt some limiting usage of these two modes when combined with bidirectional prediction. Accordingly a reduction of the complexity is achieved with, at worst, a limited loss in coding efficiency.

### REFERENCE TO RELATED APPLICATIONS

This application claims the benefit under 35 U.S.C. §119(a)-(d) of United Kingdom Patent Application No. 1300145.8, filed on Jan. 4, 2013 and entitled “Method and apparatus for encoding an image into a video bitstream and decoding corresponding video bitstream using enhanced inter layer residual prediction” and of United Kingdom Patent Application No. 1300226.6, filed on Jan. 7, 2013 and entitled “Method and apparatus for encoding an image into a video bitstream and decoding corresponding video bitstream using enhanced inter layer residual prediction”. The above cited patent applications are incorporated herein by reference in their entirety.

### FIELD OF THE INVENTION

The present invention concerns a method for encoding an image of pixels and for decoding a corresponding bit stream and it also concerns the associated devices. More particularly, it concerns residual prediction according to a spatial scalable encoding scheme. It can be considered in the context of the Scalable extension of the HEVC standard (noted SHVC), being developed by the ISO-MPEG and ITU-T standardization organizations.

### BACKGROUND OF THE INVENTION

In the HEVC scalability standard, as well as in previous standards such as the scalable extension of H.264/MPEG-4 AVC, the video is coded and decoded using a multi-layer structure. A base layer (BL), corresponding to a given quality, spatial and temporal resolution is coded. One enhancement layer (EL) is built on top of this base layer, corresponding to a higher quality, spatial or temporal resolution. Additional layers may be added to this layer. In this invention, we primarily focus on spatial scalability, in which the enhancement layer pictures are of higher spatial resolution than the base layer pictures. The man skilled in the art should understand that the invention may apply to other types of scalability like SNR (Signal-to-Noise Ratio) scalability.

Regarding inter-layer residual prediction two main variants have been proposed. A first one is called Generalized Inter-Layer Prediction (GRP or GRILP). A second one is called DIFF Inter Mode (noted DIFF Inter). In these two modes, the prediction of a given block in a picture of the EL involves a residual part built using motion compensation, firstly between data from reference and current pictures in the EL, and secondly between data from reference and current pictures in the BL. These modes involve several resource-consuming processes, in particular, the upsampling of the base layer data and the motion compensation of reference base layer and enhancement layer data. This issue is even worse when considering temporal Bi-Prediction.

### SUMMARY OF THE INVENTION

The present invention has been devised to address one or more of the foregoing concerns. It is proposed to simplify the computational complexity and the memory usage needed by the GRILP and DIFF inter modes by combining upsampling and motion compensation operations into one single operation and/or reducing the complexity of the linear filtering processes involved in some of the processes and/or adopt some limiting usage of these two modes when combined with bidirectional prediction. Accordingly a reduction of the complexity is achieved with, at worst, a limited loss in coding efficiency.

According to a first aspect of the invention there is provided a method for encoding an image of pixels according to a scalable encoding scheme having an enhancement layer and a reference layer, the method comprising for the encoding of a coding block in the enhancement layer in a coding mode called GRILP or DIFF inter (a) determining a predictor of said coding block in the enhancement layer and the associated motion vector by a motion compensation step; (b) determining a first predictor block of the coding block; (c) determining a residual predictor block based on said motion compensation step and the reference layer; (d) determining a second predictor block by adding the first predictor block and said residual predictor block; (e) predictive encoding of the coding block using said second predictor block; wherein at least one of the steps (a) to (e) involving an application of a single concatenated filter for cascading successive elementary filtering processes related to block processing including motion compensation and/or block upsampling and/or block filtering.

According to an embodiment, the determined first predictor block of the coding block is the determined predictor of said coding block in the enhancement layer.

According to an embodiment, the determined first predictor block of the coding block is the block in the reference layer co-located to said coding block.

According to an embodiment, the single concatenated filter is based on the convolution of at least two elementary filters, each elementary filter corresponding to an elementary mathematical operator.

According to an embodiment, the at least two elementary mathematical operators are the upsampling process of the reference base layer picture resulting in the upsampled reference base layer picture, and the motion compensation process of the upsampled reference base layer picture.

According to an embodiment, each block being decomposed into lines and columns, the concatenated processing operator being a two dimensional operator, this two dimensional operator being decomposed into a horizontal mono dimensional operator and a vertical mono dimensional operator, the method comprises applying the mono dimensional horizontal operator to the block's lines for obtaining an intermediate block and applying the mono dimensional vertical operator to the intermediate block's columns.

According to an embodiment, each block being decomposed into lines and columns, the concatenated processing operator being a two dimensional operator, this two dimensional operator being decomposed into a horizontal mono dimensional operator and a vertical mono dimensional operator, the method comprises applying the mono dimensional vertical operator to the block's lines for obtaining an intermediate block and applying the mono dimensional horizontal operator to the intermediate block's columns.

According to an embodiment, the single concatenated filter is based on a pre-determined interpolation filter derived from a Discrete Cosine Transform.

According to an embodiment, the single concatenated filter is based on a pre-determined interpolation filter derived from the resolution of linear equations systems function of the phases.

According to an embodiment, an image comprising at least two colour components, the pre-determined interpolation filter comprises specific values to be applied to each colour component.

According to an embodiment, each block being decomposed into lines and columns, the pre-determined interpolation filter being a two dimensional filter, this two dimensional filter being decomposed into an horizontal mono dimensional filter and a vertical mono dimensional filter, the method comprises applying the mono dimensional horizontal filter to the block's lines for obtaining an intermediate block and applying the mono dimensional vertical filter to the intermediate block's columns.

According to an embodiment, each block being decomposed into lines and columns, the pre-determined interpolation filter being a two dimensional filter, this two dimensional filter being decomposed into an horizontal mono dimensional filter and a vertical mono dimensional filter, the method comprises applying the mono dimensional vertical filter to the block's lines for obtaining an intermediate block and applying the mono dimensional horizontal filter to the intermediate block's columns.

According to an embodiment, said concatenated filter is further convolved by an attenuation window in order to reduce the filter size.

According to an embodiment, the method further comprises forbidding the GRILP encoding mode and the DIFF inter encoding mode for coding block subject to bi-predictive encoding.

According to an embodiment, the method further comprises enabling the GRILP encoding mode or the DIFF inter encoding mode for coding block subject to bi-predictive encoding based on information pertaining to the reference picture.

According to an embodiment, the method further comprises enabling the GRILP encoding mode or the DIFF inter encoding mode for coding block subject to bi-predictive encoding based on the size of the coding block.

According to an embodiment, the method further comprises enabling the GRILP encoding mode or the DIFF inter encoding mode for coding block subject to bi-predictive encoding based on the size of the block in the reference layer collocated to the coding block.

According to an embodiment, the method further comprises disabling the GRILP encoding mode or the DIFF inter encoding mode for coding block when at least one of the collocated block in the reference layer is subject to bi-predictive encoding.

According to a further aspect of the invention there is provided a method for encoding an image of pixels according to a scalable encoding scheme having an enhancement layer and a reference layer, the method comprising for the encoding of a coding block in the enhancement layer in a coding mode called GRILP or DIFF inter (a) determining a predictor of said coding block in the enhancement layer and the associated motion vector by a motion compensation step; (b) determining a first predictor block of the coding block; (c) determining a residual predictor block based on said motion compensation step and the reference layer; (d) determining a second predictor block by adding the first predictor block and said residual predictor block; (e) predictive encoding of the coding block using said second predictor block; and wherein the method further comprises (f) forbidding the GRILP encoding mode and the DIFF inter encoding mode, or enabling the GRILP encoding mode or the DIFF inter encoding mode based on information pertaining to the reference picture, or enabling the GRILP encoding mode or the DIFF inter encoding mode based on the size of the coding block, or enabling the GRILP encoding mode or the DIFF inter encoding mode based on the size of the block in the reference layer collocated to the coding block, or disabling the GRILP encoding mode or the DIFF inter encoding mode for coding block when at least one of the collocated block in the reference layer is subject to bi-predictive encoding, for coding block subject to bi-predictive encoding.

According to an embodiment, the determined first predictor block of the coding block is the determined predictor of said coding block in the enhancement layer.

According to an embodiment, the determined first predictor block of the coding block is the block in the reference layer co-located to said coding block.

According to an embodiment, the motion vector determined in the enhancement layer being determined according to a given accuracy, the method further comprises down sampling said motion vector to be used in the reference layer with an accuracy lower than the accuracy theoretically given based on the given accuracy and the spatial scalability ratio between the reference layer and the enhancement layer.

According to an embodiment, the method further comprises limiting the accuracy of the motion compensation step for coding blocks subject to bi-predictive encoding.

According to an embodiment, the method further comprises limiting the filter size used in the motion compensation step for coding blocks subject to bi-predictive encoding.

According to a further aspect of the invention there is provided a method for decoding a bit stream comprising data representing an image encoded according to a scalable encoding scheme having an enhancement layer and a reference layer, the method comprising for the decoding of said enhancement layer (a) obtaining from the bit stream the motion vector associated to a prediction of a coding block within the enhancement layer to be decoded and a residual block; (b) determining a residual predictor block based on said location and the reference layer; (c) determining a first predictor block of the coding block; (d) determining a second predictor block by adding the first predictor block and said residual predictor block; (e) reconstructing the coding unit using the second predictor block and the obtained residual block; wherein at least one of the steps (b) to (e) involving an application of a single concatenated filter for cascading successive elementary filtering processes related to block processing including motion compensation and/or block up-sampling and/or block filtering.

According to an embodiment, the determined first predictor block of the coding block is the predictor block associated with the obtained motion vector in the enhancement layer.

According to an embodiment, the determined first predictor block of the coding block is the block in the reference layer co-located to said coding block.

According to an embodiment, the single concatenated filter is based on the convolution of at least two elementary filters, each elementary filter corresponding to an elementary mathematical operator.

According to an embodiment, the at least two elementary mathematical operators are the upsampling process of the reference base layer picture resulting in the upsampled reference base layer picture, and the motion compensation process of the upsampled reference base layer picture.

According to an embodiment, each block being decomposed into lines and columns, the concatenated processing operator being a two dimensional operator, this two dimensional operator being decomposed into a horizontal mono dimensional operator and a vertical mono dimensional operator, the method comprises applying the mono dimensional horizontal operator to the block's lines for obtaining an intermediate block; applying the mono dimensional vertical operator to the intermediate block's columns.

According to an embodiment, each block being decomposed into lines and columns, the concatenated processing operator being a two dimensional operator, this two dimensional operator being decomposed into a horizontal mono dimensional operator and a vertical mono dimensional operator, the method comprises applying the mono dimensional vertical operator to the block's lines for obtaining an intermediate block and applying the mono dimensional horizontal operator to the intermediate block's columns.

According to an embodiment, the single concatenated filter is based on a pre-determined interpolation filter derived from a Discrete Cosine Transform.

According to an embodiment, the single concatenated filter is based on a pre-determined interpolation filter derived from the resolution of linear equations systems based dependent on the phases of the filter.

According to an embodiment, an image comprising at least two colour components, the pre-determined interpolation filter comprises specific values to be applied to each colour component.

According to an embodiment, each block being decomposed into lines and columns, the pre-determined interpolation filter being a two dimensional filter, this two dimensional filter being decomposed into an horizontal mono dimensional filter and a vertical mono dimensional filter, the method comprises applying the mono dimensional horizontal filter to the block's lines for obtaining an intermediate block and applying the mono dimensional vertical filter to the intermediate block's columns.

According to an embodiment, each block being decomposed into lines and columns, the pre-determined interpolation filter being a two dimensional filter, this two dimensional filter being decomposed into an horizontal mono dimensional filter and a vertical mono dimensional filter, the method comprises applying the mono dimensional vertical filter to the block's lines for obtaining an intermediate block and applying the mono dimensional horizontal filter to the intermediate block's columns.

According to an embodiment, said concatenated filter is further convolved by an attenuation window in order to reduce the filter size.

According to an embodiment, the motion vector obtained in the enhancement layer being determined according to a given accuracy, the method further comprises down sampling said motion vector to be used in the reference layer with an accuracy lower than the accuracy theoretically given based on the given accuracy and the spatial scalability ratio between the reference layer and the enhancement layer.

According to an embodiment, the method further comprises limiting the accuracy of the motion compensation step for decoding blocks subject to bi-predictive encoding.

According to an embodiment, the method further comprises limiting the filter size used in the motion compensation step for decoding blocks subject to bi-predictive encoding.
According to a further aspect of the invention there is provided a method for encoding or decoding an image of pixels according to a scalable format having an enhancement layer and a reference layer, the method comprising for the encoding or the decoding of a coding block in the enhancement layer:
   (a) determining a first predictor of said coding block in the enhancement layer using an associated motion vector;
   (b) determining a second predictor block co-located to the first predictor block in the base layer;
   (c) determining a residual predictor block as the difference between the first and the second predictor block;
   (d) motion compensating the residual predictor block using the associated motion vector;
   (e) obtaining a third predictor block by adding the motion compensated residual block to the block of the base layer co-located to the coding block
   (e) predicting the coding block using said third predictor block;
Wherein the first predictor is down-sampled to the resolution of the base layer before the determination of the residual predictor block.
According to an embodiment the associated motion vector is down-sampled to the base layer resolution before motion compensating the residual predictor block.
According to an embodiment the third predictor block is up-sampled to the resolution of the enhancement layer before the predicting step.

According to a further aspect of the invention there is provided a device for encoding an image of pixels according to a scalable encoding scheme having an enhancement layer and a reference layer, the device comprising for the encoding of a coding block in the enhancement layer in a coding mode called GRILP or DIFF inter (a) means for determining a predictor of said coding block in the enhancement layer and the associated motion vector by a motion compensation step; (b) means for determining a first predictor block of the coding block; (c) means for determining a residual predictor block based on said motion compensation step and the reference layer; (d) means for determining a second predictor block by adding the first predictor block and said residual predictor block; (e) means for predictive encoding of the coding block using said second predictor block; wherein at least one of the means (a) to (e) is configured for an application of a single concatenated filter for cascading successive elementary filtering processes related to block processing including motion compensation and/or block upsampling and/or block filtering.

According to an embodiment, the determined first predictor block of the coding block is the determined predictor of said coding block in the enhancement layer.

According to an embodiment, the determined first predictor block of the coding block is the block in the reference layer co-located to said coding block.

According to an embodiment, the single concatenated filter is based on the convolution of at least two elementary filters, each elementary filter corresponding to an elementary mathematical operator.

According to an embodiment, the at least two elementary mathematical operators are the upsampling process of the reference base layer picture resulting in the upsampled reference base layer picture, and the motion compensation process of the upsampled reference base layer picture.

According to an embodiment, each block being decomposed into lines and columns, the concatenated processing operator being a two dimensional operator, this two dimensional operator being decomposed into a horizontal mono dimensional operator and a vertical mono dimensional operator, the device comprises means for applying the mono dimensional horizontal operator to the block's lines for obtaining an intermediate block and means for applying the mono dimensional vertical operator to the intermediate block's columns.

According to an embodiment, each block being decomposed into lines and columns, the concatenated processing operator being a two dimensional operator, this two dimensional operator being decomposed into a horizontal mono dimensional operator and a vertical mono dimensional operator, the device comprises means for applying the mono dimensional vertical operator to the block's lines for obtaining an intermediate block and means for applying the mono dimensional horizontal operator to the intermediate block's columns.

According to an embodiment, the single concatenated filter is based on a pre-determined interpolation filter derived from a Discrete Cosine Transform.

According to an embodiment, the single concatenated filter is based on a pre-determined interpolation filter derived from the resolution of linear equations systems function of the phases.

According to an embodiment, an image comprising at least two colour components, the pre-determined interpolation filter comprises specific values to be applied to each colour component.

According to an embodiment, each block being decomposed into lines and columns, the pre-determined interpolation filter being a two dimensional filter, this two dimensional filter being decomposed into an horizontal mono dimensional filter and a vertical mono dimensional filter, the device comprises means for applying the mono dimensional horizontal filter to the block's lines for obtaining an intermediate block and means for applying the mono dimensional vertical filter to the intermediate block's columns.

According to an embodiment, each block being decomposed into lines and columns, the pre-determined interpolation filter being a two dimensional filter, this two dimensional filter being decomposed into an horizontal mono dimensional filter and a vertical mono dimensional filter, the device comprises means for applying the mono dimensional vertical filter to the block's lines for obtaining an intermediate block and means for applying the mono dimensional horizontal filter to the intermediate block's columns.

According to an embodiment, said concatenated filter is further convolved by an attenuation window in order to reduce the filter size.

According to an embodiment, wherein the device further comprises means for forbidding the GRILP encoding mode and the DIFF inter encoding mode for coding block subject to bi-predictive encoding.

According to an embodiment, the device further comprises means for enabling the GRILP encoding mode or the DIFF inter encoding mode for coding block subject to bi-predictive encoding based on information pertaining to the reference picture.

According to an embodiment, the device further comprises means for enabling the GRILP encoding mode or the DIFF inter encoding mode for coding block subject to bi-predictive encoding based on the size of the coding block.

According to an embodiment, the device further comprises means for enabling the GRILP encoding mode or the DIFF inter encoding mode for coding block subject to bi-predictive encoding based on the size of the block in the reference layer collocated to the coding block.

According to an embodiment, the device further comprises means for disabling the GRILP encoding mode or the DIFF inter encoding mode for coding block when at least one of the collocated block in the reference layer is subject to bi-predictive encoding.

According to a further aspect of the invention there is provided a device for encoding an image of pixels according to a scalable encoding scheme having an enhancement layer and a reference layer, the device comprising for the encoding of a coding block in the enhancement layer in a coding mode called GRILP or DIFF inter (a) means for determining a predictor of said coding block in the enhancement layer and the associated motion vector by a motion compensation step; (b) means for determining a first predictor block of the coding block; (c) means for determining a residual predictor block based on said motion compensation step and the reference layer; (d) means for determining a second predictor block by adding the first predictor block and said residual predictor block; (e) means for predictive encoding of the coding block using said second predictor block; and wherein the device further comprises (f) means for forbidding the GRILP encoding mode and the DIFF inter encoding mode, or enabling the GRILP encoding mode or the DIFF inter encoding mode based on information pertaining to the reference picture, or enabling the GRILP encoding mode or the DIFF inter encoding mode based on the size of the coding block, or enabling the GRILP encoding mode or the DIFF inter encoding mode based on the size of the block in the reference layer collocated to the coding block, or disabling the GRILP encoding mode or the DIFF inter encoding mode for coding block when at least one of the collocated block in the reference layer is subject to bi-predictive encoding, for coding block subject to bi-predictive encoding.

According to an embodiment, the determined first predictor block of the coding block is the determined predictor of said coding block in the enhancement layer.

According to an embodiment, the determined first predictor block of the coding block is the block in the reference layer co-located to said coding block.

According to an embodiment, the motion vector determined in the enhancement layer being determined according to a given accuracy, the device further comprises means for down sampling said motion vector to be used in the reference layer with an accuracy lower than the accuracy theoretically given based on the given accuracy and the spatial scalability ratio between the reference layer and the enhancement layer.

According to an embodiment, the device further comprises means for limiting the accuracy of the motion compensation step for coding blocks subject to bi-predictive encoding.

According to an embodiment, the device further comprises means for limiting the filter size used in the motion compensation step for coding blocks subject to bi-predictive encoding.

According to a further aspect of the invention there is provided a device for decoding a bit stream comprising data representing an image encoded according to a scalable encoding scheme having an enhancement layer and a reference layer, the device comprising for the decoding of said enhancement layer (a) means for obtaining from the bit stream the motion vector associated to a prediction of a coding block within the enhancement layer to be decoded and a residual block; (b) means for determining a residual predictor block based on said location and the reference layer; (c) means for determining a first predictor block of the coding block; (d) means for determining a second predictor block by adding the first predictor block and said residual predictor block; (e) means for reconstructing the coding unit using the second predictor block and the obtained residual block; wherein at least one of the means (b) to (e) is configured for an application of a single concatenated filter for cascading successive elementary filtering processes related to block processing including motion compensation and/or block upsampling and/or block filtering.

According to an embodiment, the determined first predictor block of the coding block is the predictor block associated with the obtained motion vector in the enhancement layer.

According to an embodiment, the determined first predictor block of the coding block is the block in the reference layer co-located to said coding block.

According to an embodiment, the single concatenated filter is based on the convolution of at least two elementary filters, each elementary filter corresponding to an elementary mathematical operator.

According to an embodiment, the at least two elementary mathematical operators are the upsampling process of the reference base layer picture resulting in the upsampled reference base layer picture, and the motion compensation process of the upsampled reference base layer picture.

According to an embodiment, each block being decomposed into lines and columns, the concatenated processing operator being a two dimensional operator, this two dimensional operator being decomposed into a horizontal mono dimensional operator and a vertical mono dimensional operator, the device comprises: means for applying the mono dimensional horizontal operator to the block's lines for obtaining an intermediate block and means for applying the mono dimensional vertical operator to the intermediate block's columns.

According to an embodiment, each block being decomposed into lines and columns, the concatenated processing operator being a two dimensional operator, this two dimensional operator being decomposed into a horizontal mono dimensional operator and a vertical mono dimensional operator, the device comprises means for applying the mono dimensional vertical operator to the block's lines for obtaining an intermediate block and means for applying the mono dimensional horizontal operator to the intermediate block's columns.

According to an embodiment, the single concatenated filter is based on a pre-determined interpolation filter derived from a Discrete Cosine Transform.

According to an embodiment, the single concatenated filter is based on a pre-determined interpolation filter derived from the resolution of linear equations systems function of the phases.

According to an embodiment, an image comprising at least two colour components, the pre-determined interpolation filter comprises specific values to be applied to each colour component.

According to an embodiment, each block being decomposed into lines and columns, the pre-determined interpolation filter being a two dimensional filter, this two dimensional filter being decomposed into an horizontal mono dimensional filter and a vertical mono dimensional filter, the device comprises means for applying the mono dimensional horizontal filter to the block's lines for obtaining an intermediate block and means for applying the mono dimensional vertical filter to the intermediate block's columns.

According to an embodiment, each block being decomposed into lines and columns, the pre-determined interpolation filter being a two dimensional filter, this two dimensional filter being decomposed into an horizontal mono dimensional filter and a vertical mono dimensional filter, the device comprises means for applying the mono dimensional vertical filter to the block's lines for obtaining an intermediate block and means for applying the mono dimensional horizontal filter to the intermediate block's columns.

According to an embodiment, said concatenated filter is further convolved by an attenuation window in order to reduce the filter size.

According to an embodiment, the motion vector obtained in the enhancement layer being determined according to a given accuracy, the device further comprises means for down sampling said motion vector to be used in the reference layer with an accuracy lower than the accuracy theoretically given based on the given accuracy and the spatial scalability ratio between the reference layer and the enhancement layer.

According to an embodiment, the device further comprises means for limiting the accuracy of the motion compensation step for decoding blocks subject to bi-predictive encoding.

According to an embodiment, the device further comprises means for limiting the filter size used in the motion compensation step for decoding blocks subject to bi-predictive encoding.
According to a further aspect of the invention there is provided a device for encoding or decoding an image of pixels according to a scalable format having an enhancement layer and a reference layer, the device comprising for the encoding or the decoding of a coding block in the enhancement layer:
   (a) a means for determining a first predictor of said coding block in the enhancement layer using an associated motion vector;
   (b) a means for determining a second predictor block co-located to the first predictor block in the base layer;
   (c) a means for determining a residual predictor block as the difference between the first and the second predictor block;
   (d) a means for motion compensating the residual predictor block using the associated motion vector;
   (e) a means for obtaining a third predictor block by adding the motion compensated residual block to the block of the base layer co-located to the coding block
   (e) a means for predicting the coding block using said third predictor block;
   Wherein the device comprises a means for down-sampling the first predictor to the resolution of the base layer before the determination of the residual predictor block.
   In an embodiment the associated motion vector is down-sampled to the base layer resolution before motion compensating the residual predictor block
   In an embodiment the third predictor block is up-sampled to the resolution of the enhancement layer before the predicting step.

According to a further aspect of the invention there is provided a computer program product for a programmable apparatus, the computer program product comprising a sequence of instructions for implementing a method according to the invention, when loaded into and executed by the programmable apparatus.

According to a further aspect of the invention there is provided a computer-readable storage medium storing instructions of a computer program for implementing a method according to the invention.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates the relations between the different picture representations of images in a scalable encoding architecture;

FIGS. 2a and 2b illustrates the principle of inter and intra coding;

FIGS. 3a and 3b illustrates scalable encoding as implemented in prior art;

FIG. 4 illustrates the residual prediction as implemented in prior art;

FIG. 5 illustrates the method used for residual prediction in an embodiment of the invention;

FIG. 6 illustrates the method used for decoding in an embodiment of the invention;

FIG. 7 illustrates a block diagram of a typical scalable video coder generating 2 scalability layers;

FIG. 8 illustrates a block diagram of a decoder which may be used to receive data from an encoder according an embodiment of the invention;

FIG. 9 illustrates a first embodiment for implementing the GRILP mode;

FIG. 10 illustrates the DIFF Inter mode;

FIG. 11 illustrates a second embodiment for implementing the GRILP mode;

FIG. 12 illustrates a new embodiment for implementing the GRILP mode;

FIG. 13 illustrates the concatenated upsampling and motion compensation process applied first in horizontal then in vertical dimensions;

FIG. 14 illustrates the GRILP mode in case of Bi-Prediction in the reference layer;

FIG. 15 illustrates a restriction applied to the GRILP mode in case of Bi-Prediction in the reference layer;

FIG. 16 illustrates an embodiment of the DIFF inter mode where the motion compensation step is performed at the base layer resolution.

### DETAILED DESCRIPTION OF THE PREFERRED EMBODIMENT

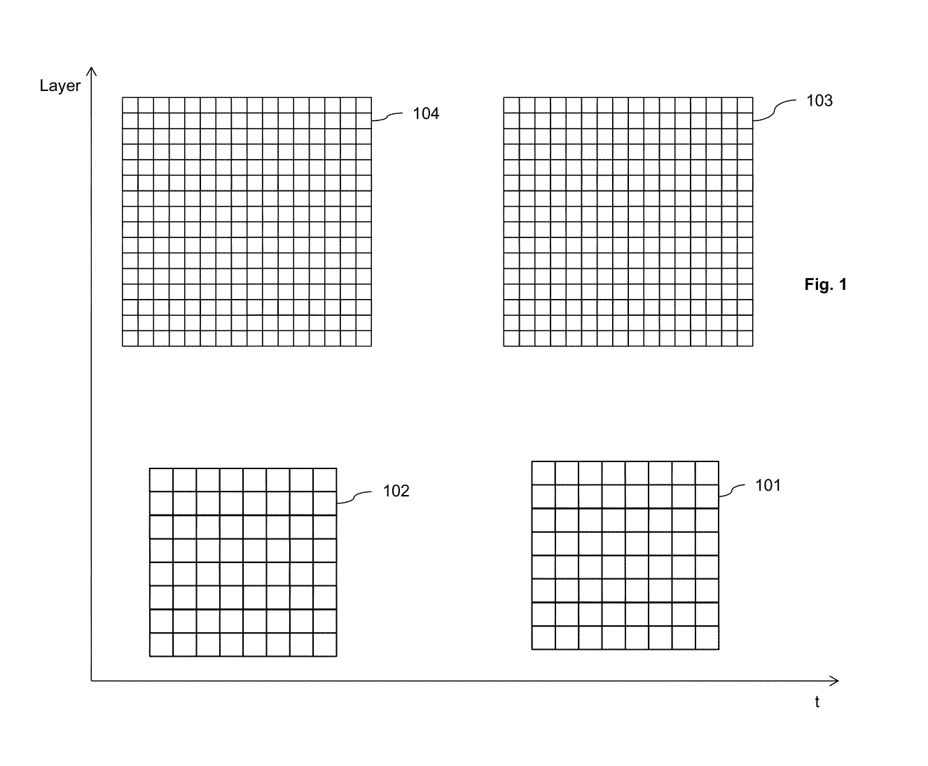

Scalable video coding is based on the principle of encoding a base layer in low quality or resolution and some enhancement layers with complementary data allowing the encoding or decoding of some enhanced versions of this base layer. The image within a sequence to be encoded or decoded is considered as having several picture representations, corresponding to each layer, the base layer and each of the actual enhancement layers. A coded picture within a given scalability layer is called a picture representation level. Typically, the base layer picture representation of an image corresponds to a low resolution version of the image while the picture representations of successive layers correspond to higher resolution versions of the image. This is illustrated in FIG. 1, illustrating two successive images having two layers. Image 101 corresponds to the base layer picture representation of image at time t. Image 102 corresponds to the base layer picture representation of image at time t−1. Image 103 corresponds to the enhancement layer picture representation of image at time t. Image 104 corresponds to the enhancement layer picture representation of image at time t−1. It should be understood that in scalable encoding, the encoding of an enhancement layer is made relative to another layer used as a reference and that this reference layer is not necessarily the base layer; thus, the term reference layer (RL) will be used instead of base layer. It is worth noting that while the term “reference” is used to designate the reference layer for the outstanding enhancement layer, it is also used to designate the reference image or picture representation used in motion estimation operation.

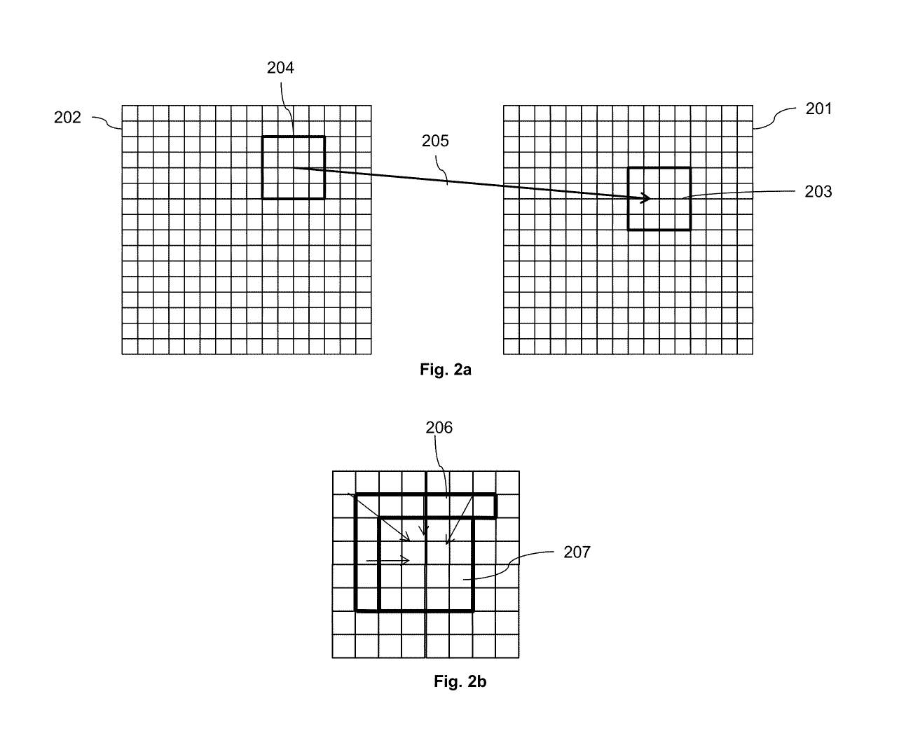

FIGS. 2a and 2b illustrates the principle of inter and intra coding. Typically an image is divided into coding blocks, typically of square shapes, often called blocks as coding block 203 or 207. The coding blocks are encoded or decoded using predictive encoding. Predictive encoding is based on determining data whose values are an approximation of the pixel data to encode or decode, this data being called a predictor of the coding block. The difference between this predictor and the coding block to be encoded or decoded is called the residual. Encoding consists, in this case, of encoding the location of the predictor and the residual. A good predictor is a predictor whose values are close to the values of the coding block, leading to a residual of small value that can be efficiently encoded.

Each coding block may be encoded based on predictors from previously encoded images, a coding mode called “inter” coding. It may be noted that “previous” does not refer exclusively to a previous image in the temporal sequence of video. It refers instead to the sequential encoding or decoding scheme and means that the “previous” image has been encoded or decoded previously and may therefore be used as a reference image for the encoding of the current image. For example, in FIG. 2a, block 204 in previous image 202 is used as a predictor of coding block 203 in image 201. In this case, the location is indicated by a vector 205 giving the location of the predictor in the previous image relative to the location of the coding block in the image to encode. It may be also encoded based on information already encoded and decoded in the image to encode. In this case, illustrated by FIG. 2b, the predictor is obtained from the left and above border pixels 206 of the coding block 207 and a vector giving prediction direction. This predictive mode is called “intra” coding.

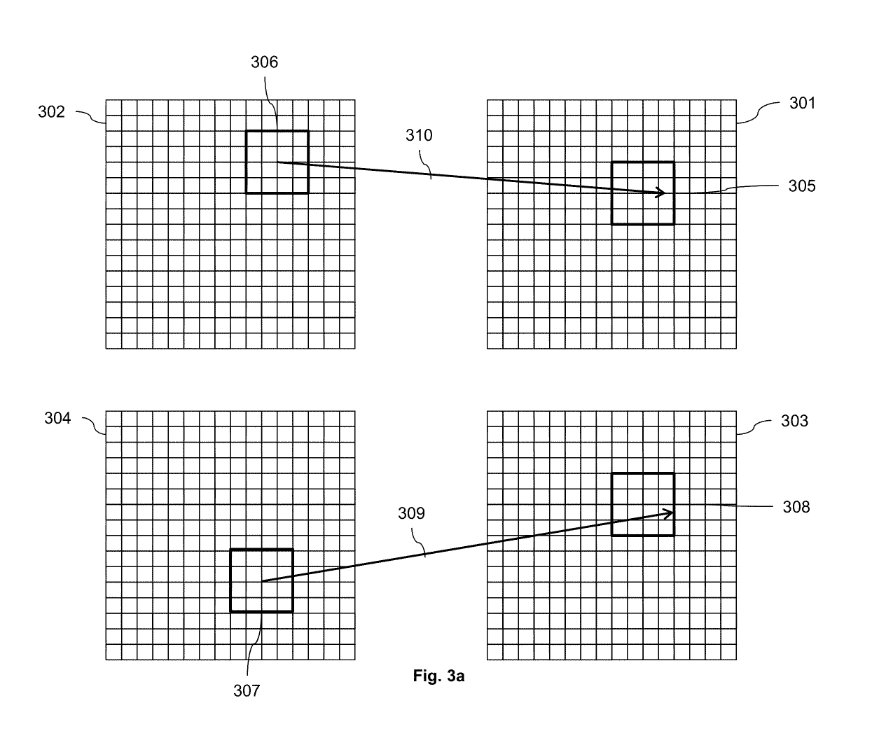

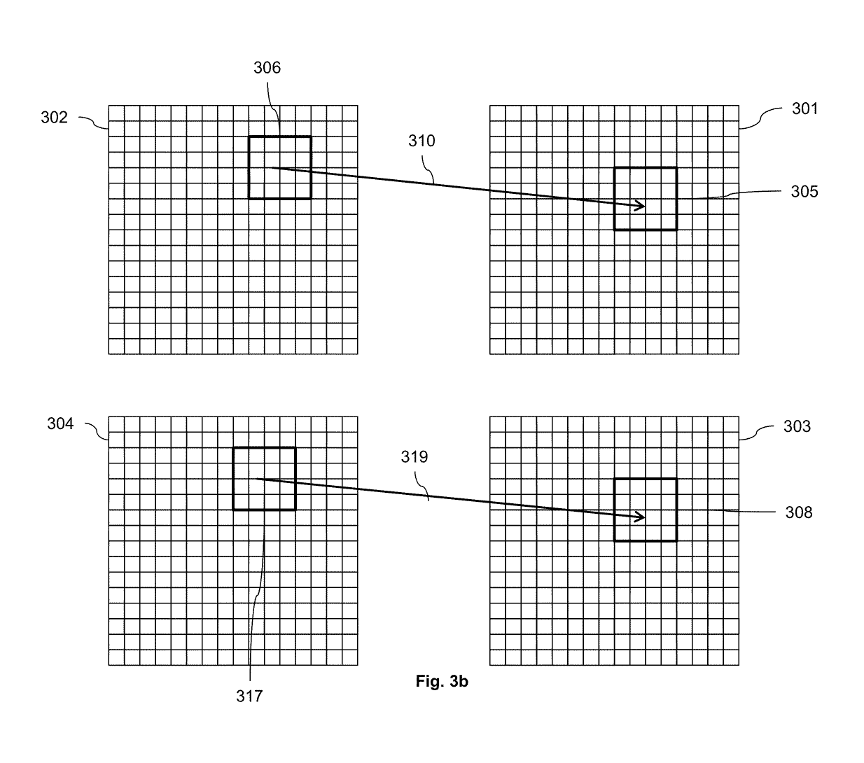

FIG. 3a illustrates scalable encoding as implemented, for example, in the Scalable extension of the H.264/MPEG-4 AVC standard, called SVC. The image to be encoded at time t has two picture representations: a picture representation 303 in the reference layer and a picture representation 301 in the enhancement layer. The previous image, typically already encoded or decoded, has picture representations 304 in the reference layer and 302 in the enhancement layer. In the reference layer, the coding block 308 has been encoded using the predictor 307 and the motion vector 309. In the enhancement layer, the coding block 305, co-located with the coding block 308 of the reference layer, is encoded using the predictor 306 and the motion vector 310. The motion vectors 309 and 310 are illustrated as being very different as they result from independent block matching procedures. FIG. 3b illustrates the same scheme where motion vectors 310 in the enhancement layer and 319 in the base layer corresponding to predictor 317 are strongly correlated. This leads to residual data in the base and the enhancement layer that are correlated.

However, note that the motion vector 310 associated to a current enhancement coding block 305 may differ strongly from the motion vector of the co-located coding block 308 in the reference layer. Indeed, motion vectors are selected by the encoder side according to a rate distortion criterion. The rate distortion optimized motion vector selection aims at finding a good predictor 306 of a current coding block 305 in the reference picture 302, while keeping the coding cost of resulting motion vector and residual data acceptable. This may lead to quite different results in two different scalability layers, especially as the quality parameters used to code each layer differ between layers.

The term “co-located” in this document concerns pixels or set of pixels having the same spatial location within two different image picture representations, and is a wording well-known to the man skilled in the art. It is mainly used to define two blocks of pixels (one in the enhancement layer and the other in the reference layer) which have the same spatial location in the two layers, taking into account the scaling factor in case of resolution change between two layers. It may also be used for two successive images in time. It may also refer to entities related to co-located data, for example when talking about co-located residual.

It is to be noted that, at decoding time, when decoding a particular picture representation the only data we can use are the picture representations already decoded. To fit the decoding and have a perfect match between encoding and decoding, the encoding of a particular picture representation is based on decoded version of previously encoded picture representations. This is known as the principle of causal coding.

It is considered that when encoding or decoding an enhancement layer picture, its corresponding reference layer picture has been fully processed and reconstructed, and is therefore available for the prediction of the enhancement layer picture. Previously processed enhancement and reference layer pictures are also typically available for the prediction of the enhancement layer picture when this picture is coded as an ‘inter’ picture, namely predicted from previously processed pictures.

The encoding/decoding of the enhancement layer is predictive, meaning that a predictor 306 is found in the previous image 302 to encode the coding block 305 in the original picture representation 301. This encoding leads to the computation of a residual, called the first order residual block, being the difference between the coding block 305 and its predictor 306. It may be attempted to improve the encoding by performing a second order prediction, namely by using predictive encoding of this first order residual block itself. The SVC standard offers the possibility of predicting the residual of a temporally predicted block in the enhancement layer from the residual of a co-located temporally predicted block in the reference layer. This inter layer residual prediction (ILRP) mode is mainly based on the assumption that the enhancement and the reference layer motions are strongly correlated. As can be seen in FIG. 3b, predicted blocks 305 in the enhancement layer and 308 in the reference layer have a similar motion vector 310 and 319. On that condition, it can be assumed that the residual of block 308 given according to motion vector 319 is similar to the residual of block 305 given according to motion vector 310. The first order residual block 308, corresponding to motion vector 319 offers a good predictor for the first order residual block 305, corresponding to motion vector 310. In other words, the residual block given by subtracting block 317 from block 308 is used as a predictor of the residual block given by subtracting block 306 from block 305. In that case the enhancement layer block is coded in the form of a mode indicator indicating the IRLP mode and a second order residual corresponding to the difference between the two first order residual blocks.

Actually, the assumption that co-located enhancement and reference layer coding blocks have strongly correlated motion vectors is rarely verified. As already explained, the motion vector choice in the enhancement layer depends on the rate/distortion properties of each candidate considered during the motion estimation process. These rate/distortion properties may strongly differ from a layer to another one, since each layer is encoded with its own resolution and quality level.

In order to address these concerns, it has been proposed to compute the inter-layer residual using the actual motion vector applied for the enhancement layer picture, possibly rescaled according to the spatial ratio between the reference layer and the enhancement layer resolutions. In the Generalized Inter-Layer Prediction (GRILP) mode, the reference-layer residual block (RL residual block) is determined as the difference between the samples from the co-located coding block in the reference layer and the determined block predictor in the reference layer (the RL block predictor), and each sample of said further residual block corresponds to a difference between a sample of the enhancement layer residual block and a corresponding sample of the reference layer residual block.

In the DIFF Inter mode, the reference layer residual block (RL residual block) is determined as the difference between the enhancement layer block prediction (the EL block predictor) and the determined block predictor in the reference layer (the RL block predictor), possibly upsampled according to the spatial ratio between the RL and EL pictures resolutions. In DIFF inter mode, the RL residual block is then added to the samples from the co-located coding block in the reference layer, again possibly upsampled. So these 2 modes mostly differ in the order of the processes, but conceptually perform similar prediction processes.

GRILP and DIFF Inter modes can apply to temporal inter prediction: the obtained block predictor candidate of the coding block is in a previously encoded image. They can also apply to spatial intra prediction: the obtained predictor candidate of the coding block is obtained from a previously encoded part of the same image the coding block belongs to.

The approach symmetrically applies to the decoder side.

When applied during temporal inter prediction, the picture representations used in the reference layer to compute the reference-layer residual block correspond to some of the reference picture representations stored in the decoded picture buffer of the reference layer.

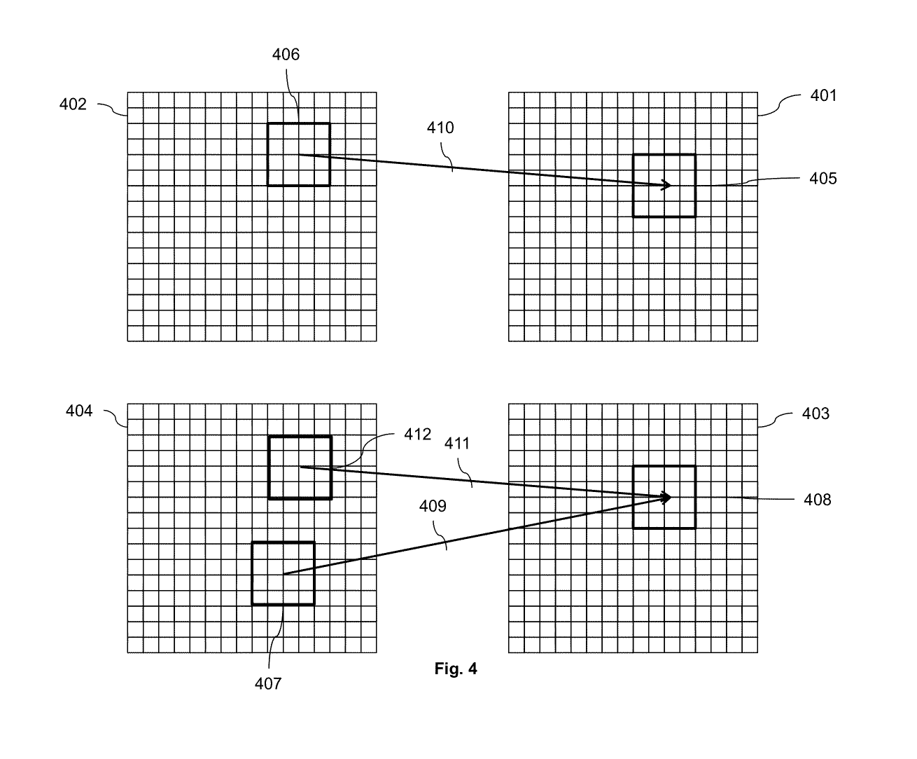

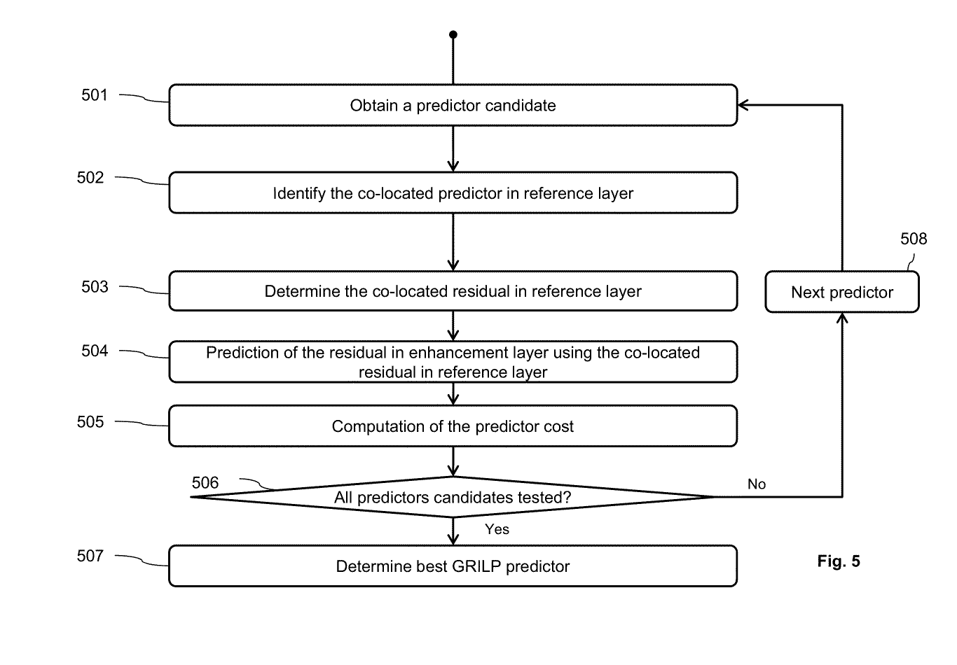

The prediction of the residual will now be described in relation with FIG. 4 and FIG. 5. The image to encode, or decode, is the picture representation 401 in the enhancement layer. This image is constituted of the original pixels. The picture representation 402 in the enhancement layer is available in its reconstructed version. Regarding the reference layer, it depends on the scalable decoder architecture considered. If the encoding mode is single loop, meaning that the reference layer reconstruction is not brought to completion, the picture representation 404 is composed, firstly of inter blocks decoded until obtaining their residual but to which is not applied the motion compensation, and secondly of intra blocks that may be integrally decoded as in SVC or partially decoded until obtaining their intra prediction residual and a prediction direction. Note that in FIG. 4, both layers are represented at the same resolution as in SNR scalability. In Spatial scalability, two different layers will have different resolutions which require an up-sampling of the residual and motion information before performing the prediction of the residual.

Where the encoding mode is multi loop, a complete reconstruction of the reference layer is conducted. In this case, picture representation 404 of the previous image and picture representation 403 of the current image both in the reference layer are available in their reconstructed version.

A competition is performed between all modes available in the enhancement layer to determine mode optimizing a rate-distortion trade off. The GRILP mode is one of the modes in competition for encoding a block of an enhancement layer.

We describe a first version of the GRILP adapted to temporal prediction in the enhancement layer. This embodiment starts with the determination of the best temporal GRILP predictor in a set comprising several potential temporal GRILP predictors obtained using a block matching algorithm.

In a first step 501, a predictor candidate contained in the search area of the motion estimation algorithm is obtained for block 405. This predictor candidate represents an area of pixels 406 in the reconstructed reference image 402 in the enhancement layer pointed by a motion vector 410. A difference between block 405 and block 406 is then computed to obtain a first order residual block in the enhancement layer. For the considered reference area 406 in the enhancement layer, the corresponding co-located area 412 in the reconstructed reference layer image 404 in the base layer is identified in step 502. In step 503 a difference is computed between block 408 and block 412 to obtain a first order residual block for the base layer. In step 504, a prediction of the first order residual block of the enhancement layer by the first order residual block of the reference layer is performed. During this prediction, the difference between the first order residual block of the enhancement layer and the first order residual block of the reference layer is computed. This last prediction allows obtaining a second order residual. It is to be noted that the first order residual block of the reference layer does not correspond to the residual used in the predictive encoding of the reference layer which is based on the predictor 407. This first order residual block is a kind of virtual residual obtained by reporting in the reference layer the motion vector obtained by the motion estimation conducted in the enhancement layer. Accordingly, by being obtained from co-located pixels, it is expected to be a good predictor for the residual obtained in the enhancement layer. To emphasize this distinction and the fact that it is obtained from co-located pixels, it will be called the co-located residual in the following.

In step 505, the rate distortion cost of the GRILP mode under consideration is evaluated. This evaluation is based on a cost function depending on several factors. An example of such a cost function is:

C=D+λ(Rₛ+Rₘᵥ+Rᵣ);

where C is the obtained cost, D is the distortion between the original coding block to encode and its reconstructed version after encoding and decoding. Rₛ+Rₘᵥ+Rᵣ represents the bitrate of the encoding, where Rₛ is the component for the size of the syntax element representing the coding mode, Rₘᵥ is the component for the size of the encoding of the motion information, and Rᵣ is the component for the size of the second order residual. λ is the usual Lagrange parameter.

In step 506, a test is performed to determine if all predictor candidates contained in the search area have been tested. If some predictor candidates remain, the process loops back to step 501 with a new predictor candidate. Otherwise, all costs are compared during step 507 and the predictor candidate minimizing the rate distortion cost is selected. The cost of the best GRILP predictor will be then compared to the costs of other predictors available for blocks in an enhancement layer to select the best prediction mode. If the GRILP mode is finally selected, a mode identifier, the motion information and the encoded residual are inserted in the bit stream.

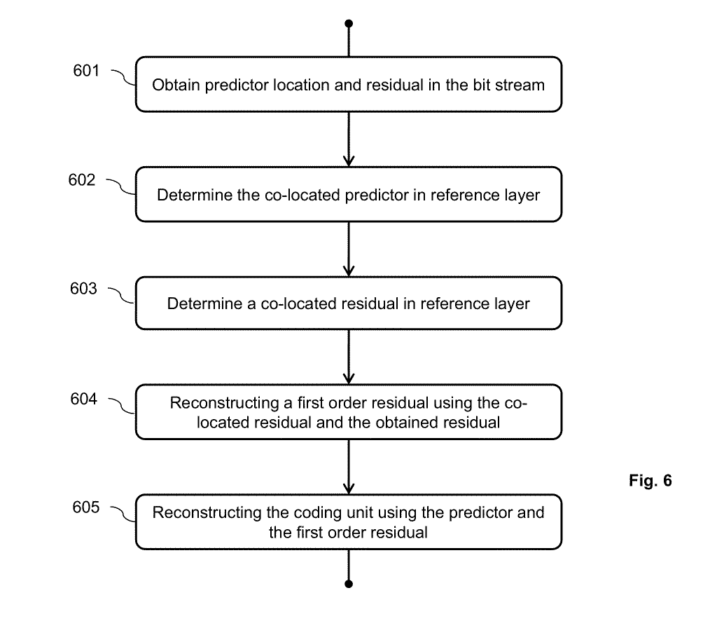

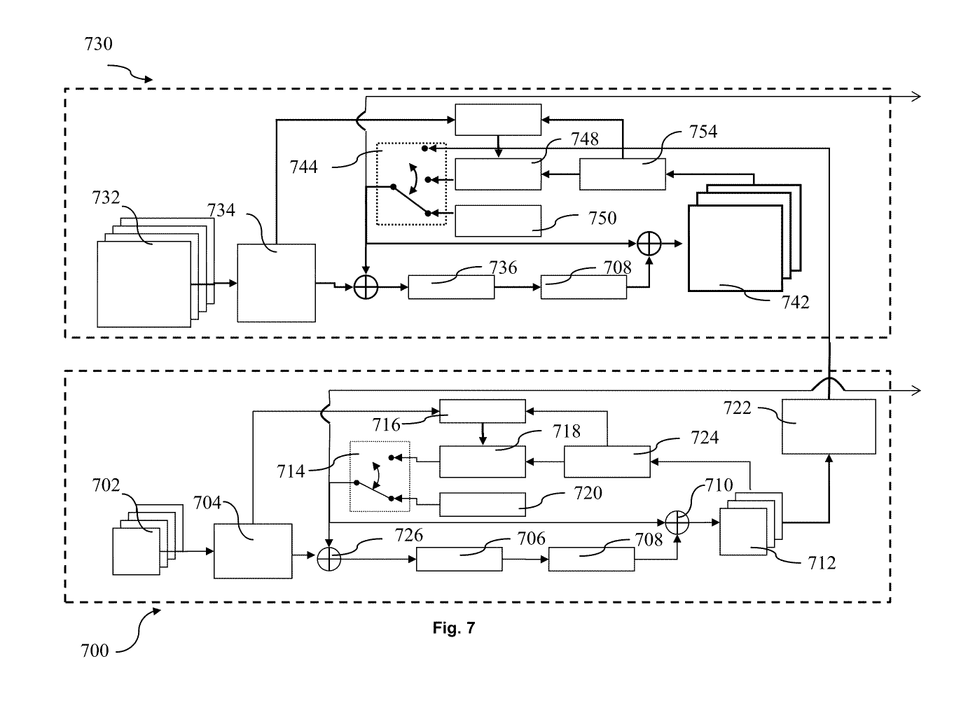

The decoding of the GRILP mode is illustrated by FIG. 6. The bit stream comprises the means to locate the predictor and the second order residual. In a first step 601, the location of the predictor used for the prediction of the coding block and the associated residual are obtained from the bit stream. This residual corresponds to the second order residual obtained at encoding. In a step 602, the co-located predictor is determined. It is the location in the reference layer of the pixels corresponding to the predictor obtained from the bit stream. In a step 603, the co-located residual is determined. It is defined by the difference between the co-located coding block and the co-located predictor in the reference layer. In a step 604, the first order residual block is reconstructed by adding the residual obtained from the bit stream which corresponds to the second order residual and the co-located residual. Once the first order residual block has been reconstructed, it is used with the predictor which location has been obtained from the bit stream to reconstruct the coding block in a step 605.

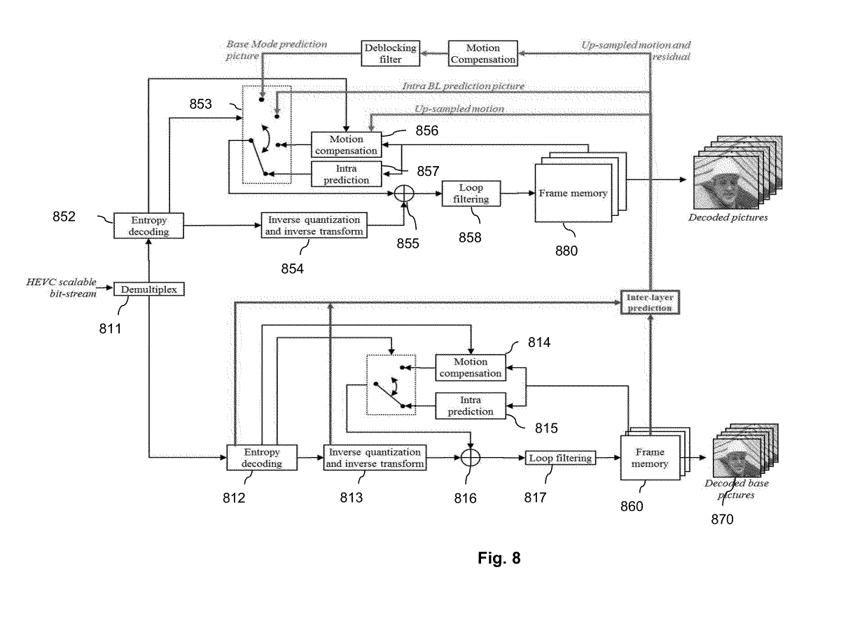

FIG. 7 provides a block diagram of a typical scalable video coder generating two scalability layers. This diagram is organized in two stages 700, 730, respectively dedicated to the coding of each of the scalability layers generated. The numerical references of similar functions are incremented by 30 between the successive stages. Each stage takes, as an input, the original sequence of images to be compressed, respectively 702 and 732, possibly subsampled at the spatial resolution of the scalability layer at considered stage. Within each stage a motion-compensated temporal prediction loop is implemented.

The first stage 700 in FIG. 7 corresponds to the encoding diagram of an H.264/AVC or HEVC non-scalable video coder and is known to persons skilled in the art. It successively performs the following steps for coding the base layer. A current image 702 to be compressed at the input to the coder is divided into coding blocks, by the function 704. Each coding block, first of all undergoes a motion estimation step 716, comprising a block matching algorithm, which attempts to find, among reference images stored in a buffer 712, reference prediction units for best predicting the current coding block. This motion estimation function 716 supplies one or more indices of reference images containing the reference prediction units found, as well as the corresponding motion vectors. A motion compensation function 718 applies the estimated motion vectors to the reference prediction units found and copies the blocks thus obtained, which provides a temporal prediction block. In addition, an INTRA prediction function 720 determines the spatial prediction mode of the current coding block that would provide the best performance for the coding of the current coding block in INTRA mode. Next a function of choosing the coding mode 714 determines, among the temporal and spatial predictions, the coding mode that provides the best rate-distortion compromise in the coding of the current coding block. The difference between the current coding block and the prediction coding block thus selected is calculated by the function 726, so as to provide a residue (temporal or spatial) to be compressed. This residual coding block then undergoes a spatial transform (such as the discrete cosine transform or DCT) and quantization functions 706 to produce quantized transform coefficients. An entropy coding of these coefficients is then performed, by a function not shown in FIG. 7, and supplies the compressed texture data of the current coding blocks.

Finally, the current coding block is reconstructed by means of a reverse quantization and reverse transformation 708, and an addition 710 of the residue after reverse transformation and the prediction coding block of the current coding block. Once the current image is thus reconstructed, it is stored in a buffer 712 in order to serve as a reference for the temporal prediction of future images to be coded.

Function 724 performs a post filtering operations comprising a deblocking filter and Sample adaptive Offset (SAO). These post filter operations aim at reducing the encoding artifacts.

The second stage in FIG. 7 illustrates the coding of a first enhancement layer 730 of the scalable stream. This stage 730 is similar to the coding scheme of the base layer, except that, for each coding of a current image in the course of compression, additional prediction modes, compared to the coding of the base layer, may be chosen by the coding mode selection function 744. These prediction modes called “inter-layer prediction modes” may comprise several modes. These modes consist of reusing the coded data in a reference layer below the enhancement layer currently being coded as prediction data of the current coding block.

In the case where the reference layer contains an image that coincides in time with the current image, then referred to as the “base image” of the current image, the co-located coding block may serve as a reference for predicting the current coding block. More precisely, the coding mode, the coding block partitioning, the motion data (if present) and the texture data (residue in the case of a temporally predicted coding block, reconstructed texture in the case of a coding block coded in INTRA) of the co-located coding block can be used to predict the current coding block. In the case of a spatial enhancement layer, (not shown) up-sampling operations are applied on texture and motion data of the reference layer. These inter layer prediction modes comprise the Generalized Residual Inter Layer Prediction (GRILP) Mode.

In addition to the inter layer prediction modes, each coding block of the enhancement layer can be encoded using usual H.264/AVC or HEVC modes based on temporal or spatial prediction. The mode providing the best rate-distortion compromise is then selected by block 744.

FIG. 8 is a block diagram of a scalable decoding method for application on a scalable bit-stream comprising two scalability layers, e.g. comprising a base layer and an enhancement layer. The decoding process may thus be considered as corresponding to reciprocal processing of the scalable coding process of FIG. 7. The scalable bit stream being decoded, as shown in FIG. 7, is made of one base layer and one spatial enhancement layer on top of the base layer, which are demultiplexed in step 811 into their respective layers. It will be appreciated that the process may be applied to a bit stream with any number of enhancement layers.

The first stage of FIG. 8 concerns the base layer decoding process. The decoding process starts in step 812 by entropy decoding each coding block of each coded image in the base layer. The entropy decoding process 812 provides the coding mode, the motion data (reference images indexes, motion vectors of INTER coded coding blocks) and residual data. This residual data includes quantized and transformed DCT coefficients. Next, these quantized DCT coefficients undergo inverse quantization (scaling) and inverse transform operations in step 813. The decoded residual is then added in step 816 to a temporal prediction area from motion compensation 814 or an Intra prediction area from Intra prediction step 815 to reconstruct the coding block. Loop filtering is effected in step 817. The so-reconstructed residual data is then stored in the frame buffer 860. The decoded motion and temporal residual for INTER coding blocks may also be stored in the frame buffer. The stored frames contain the data that can be used as reference data to predict an upper scalability layer. Decoded base images 870 are obtained.

The second stage of FIG. 8 performs the decoding of a spatial enhancement layer on top of the base layer decoded by the first stage. This spatial enhancement layer decoding includes entropy decoding of the enhancement layer in step 852, which provides the coding modes, motion information as well as the transformed and quantized residual information of coding blocks of the enhancement layer.

A subsequent step of the decoding process involves predicting coding blocks in the enhancement image. The choice 853 between different types of coding block prediction (INTRA, INTER, inter-layer prediction modes) depends on the prediction mode obtained from the entropy decoding step 852. In the same way as on the encoder side, these prediction modes consist in the set of prediction modes of HEVC, which are enriched with some additional inter-layer prediction modes.

The prediction of each enhancement coding block thus depends on the coding mode signalled in the bit stream. According to the CU coding mode the coding blocks are processed as follows:
In the case of an inter-layer predicted INTRA coding block, the enhancement coding block is reconstructed by undergoing inverse quantization and inverse transform in step 854 to obtain residual data and adding in step 855 the resulting residual data to Intra prediction data from step 857 to obtain the fully reconstructed coding block. Loop filtering is then effected in step 858 and the result stored in frame memory 880;
In the case of an INTER coding block, the reconstruction involves the motion compensated temporal prediction 856, the residual data decoding in step 854 and then the addition of the decoded residual information to the temporal predictor in step 855. In such an INTER coding block decoding process, inter-layer prediction can be used in two ways. First, the temporal residual data associated with the considered enhancement layer coding block may be predicted from the temporal residual of the co-located coding block in the base layer by means of generalized residual inter-layer prediction. Second, the motion vectors of prediction units of a considered enhancement layer coding block may be decoded in a predictive way, as a refinement of the motion vector of the co-located coding block in the base layer;
In the case of an inter-layer intra RL coding mode, the result of the entropy decoding of step 852 undergoes inverse quantization and inverse transform in step 854, and then is added in step 855 to the co-located coding block of current coding block in base image, in its decoded, post-filtered and up-sampled (in case of spatial scalability) version;
In the case of Base-Mode prediction the result of the entropy decoding of step 852 undergoes inverse quantization and inverse transform in step 854, and then is added to the co-located area of current CU in the Base Mode prediction in step 855; base mode prediction consists of inheriting in the EL block the block structure and motion data from the co-located RL blocks; then the EL block is predicted by motion compensation using the inherited motion data (for the parts of the EL block whose RL blocks are inter-coded) or using the intra RL mode (for the parts of the EL block whose RL blocks are intra-coded). Second order Residual prediction may also apply.

As already seen with reference to step 744 in FIG. 7, a competition is performed at the encoder side between all modes available in the enhancement layer to determine the mode optimizing a rate-distortion trade-off. The GRILP mode is one of the modes in competition for encoding a block of an enhancement layer. At the decoder side, a plurality of modes can be signalled for a coding block. If the GRILP mode is signalled for a given coding block, the GRILP process, as described above, applies.

The following equation schematically describes the GRILP mode process to generate the EL prediction signal PRED_{EL}:

PRED_{EL}=MC₁[REF_{EL},MV_{EL}]+{UPS(REC_{RL})−MC₂[UPS(REF_{RL}),MV_{EL}]}

In this equation,
PRED_{EL} corresponds to the prediction of the EL coding block being processed;
REC_{RL} is the co-located block from the reconstructed RL picture, corresponding to the current EL picture;
MV_{EL} is the motion vector used for the temporal prediction in the EL
REF_{EL} is the reference EL picture;
REF_{RL} is the reference RL picture;
UPS(x) is the upsampling operator performing the upsampling of samples from picture x; it applies to the RL samples;
MC₁[x,y] is the EL operator performing the motion compensated prediction from the picture x using the motion vector y;
MC₂[x, y] is the RL operator performing the motion compensated prediction from the picture x using the motion vector y;
{UPS(REC_{RL})−MC₂[UPS(REF_{RL}),MV_{EL}]} represents the residual predictor.

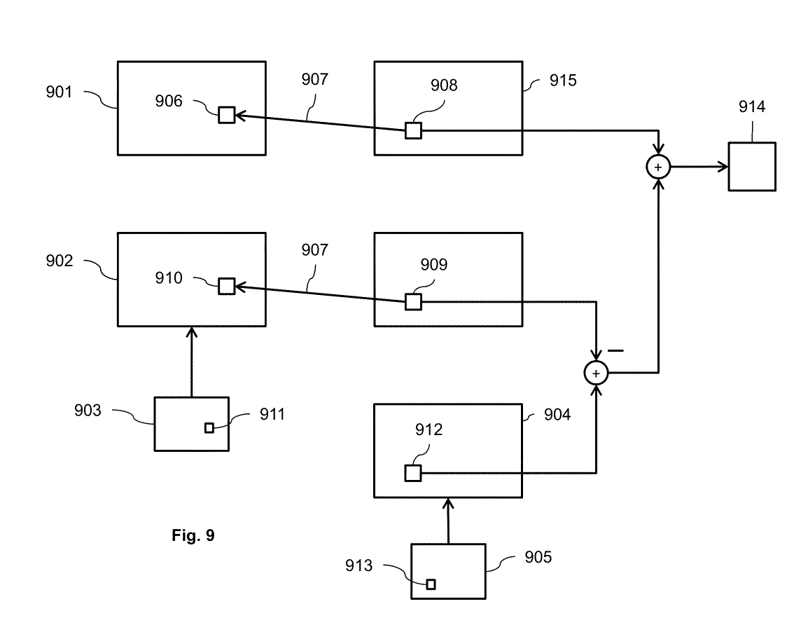

FIG. 9 illustrates the computation of the predictor in GRILP according to the foregoing equation. Let's consider a coding block to be encoded in the picture representation 915 in the enhancement layer. This coding block is of size H lines×W columns. Its corresponding col-ocated block 913 in the RL picture 905 is of size h lines×w columns. W/w and H/h correspond to the inter-layer spatial resolution ratios. A block 908 of size H×W is obtained by motion compensation MC₁ of a block 906 of size H×W in the reference EL picture representation REF_{EL} 901 using the motion vector MV_{EL} 907. A block 909 of size H×W is obtained by motion compensation MC₂ of a block 910 of size H×W of the upsampled reference RL picture representation 902 using the same motion vector MV_{EL} 907. The block 910 has been derived by upsampling the block 911 of size h×w from the RL reference picture representation REF_{RL} 903. The block 912 of size H×W, in the upsampled RL picture representation 904, is the upsampled version of the block 913 of size h×w from the current RL picture representation REC_{RL} 905. Samples of block 909 are subtracted to samples of block 912 to generate the second order residual, which is added to the block 908 to generate the final EL prediction block PRED_{EL} 914. In other words, the final enhancement layer prediction block 914 corresponds to the predictor obtained by motion estimation in the enhancement layer, the block 908, plus the residual obtained for the collocated block in the upsampled reference layer obtained with the same motion vector.

As mentioned previously, the DIFF inter mode obtains the same result by applying the operations in a different order. The DIFF inter mode corresponds to the following equation:

PRED_{EL}=UPS(REC_{RL})+MC₃[REF_{EL}−UPS(REF_{EL}),MV_{EL}]

where MC₃ may be MC₁ or MC₂ or a different operator.

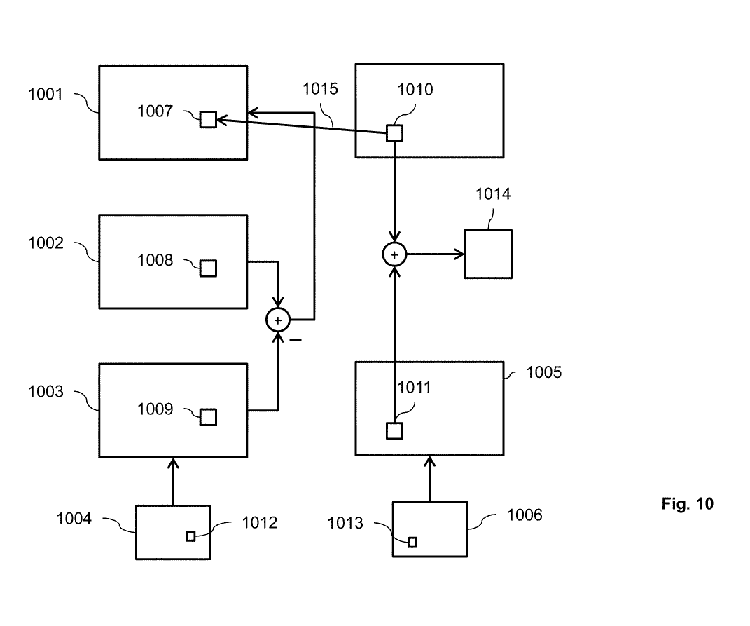

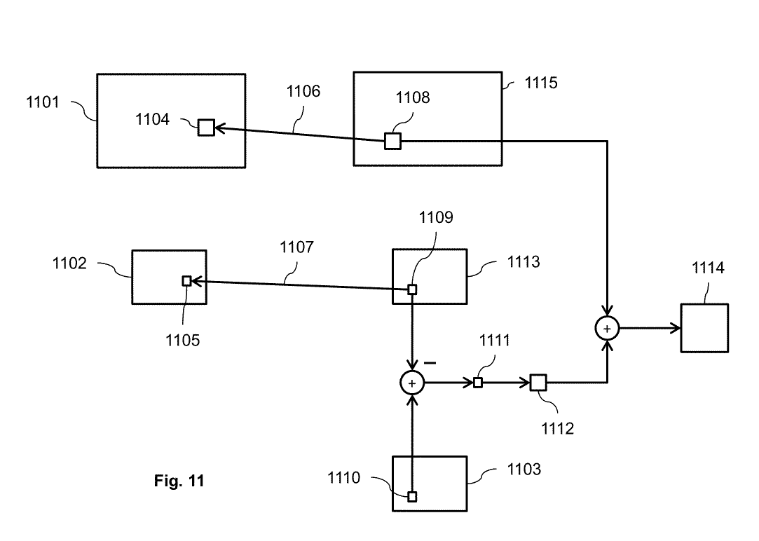

This is illustrated in FIG. 10. This mode is based on taking the co-located block in the reference layer as a predictor for a block in the enhancement layer. A prediction of the residual is made based on motion estimation in the reference image. First, the reference picture representation in the reference layer 1004 is upsampled to give the picture representation 1003. This picture representation is subtracted to the reference picture representation in the enhancement layer 1002. It results in a picture representation 1001 being a residual picture representation of the enhancement layer based on the reference layer for the reference image. Alternatively to the complete upsampling and subtracting operation on the whole picture representations, these operations may be carried out on demand on corresponding block 1012, 1009 and 1008 to result in block 1007. The block 1010 of size H×W is the motion compensation MC₃, with the motion vector MV_{EL} 1015, of the block 1007 of size H×W in picture representation 1001. At the encoder side, the motion vector MV_{EL} 1015 is given by a regular motion estimation of the coding block in the enhancement layer based on the reference picture representation in the enhancement layer. At the decoder, the motion vector MV_{EL} 1015 is decoded from the bit stream for the prediction or coding block in the enhancement layer. Block 1010 is added to block 1011 of size H×W which belongs to the upsampled current RL picture 1005, resulting from the upsampling of block 1013 of size h×w from the RL picture representation REC_{RL} 1006. This gives the EL prediction block PRED_{EL} 1014. In other words, the final enhancement layer prediction block 1014 corresponds to the predictor corresponding to the upsampled version of the block in the reference layer co-located to the coding block, namely the block 1011, plus a residual predictor obtained by subtracting in the reference image the reference layer from the enhancement layer for the block corresponding the motion estimation carried out in the enhancement layer.

Typically, during the computation, the following picture representations are stored in memory: the picture representation of the current image to encode in the enhancement layer, the picture representation of the previous image in the enhancement layer in its reconstructed version, the picture representation of the current image in the reference layer in its reconstructed version, and the picture representation of the previous image in the reference layer in its reconstructed version. The reference layer picture representations are typically upsampled to fit the resolution of the enhancement layer.

Advantageously, the blocks in the reference layer are upsampled only when needed instead of upsampling the whole picture representation at once. The encoder and the decoder may be provided with on-demand block upsampling means to achieve the upsampling. Alternatively, to save some computation, the upsampling is done on the block data only, meaning that the upsampling filters do not use the neighbours value from other blocks as it would be done when upsampling the complete picture representation. The decoder must use the same upsampling function to insure proper decoding. It is to be noted that all the blocks of a picture representation are typically not encoded using the same coding mode. Therefore, at decoding, only some of the blocks are to be decoded using the GRILP or DIFF inter mode herein described. Using on-demand block upsampling means is then particularly advantageous at decoding as only some of the blocks of a picture representation have to be upsampled during the process.

In a particular embodiment, which is advantageous in terms of memory saving, the residual computations are done at the reference layer resolution. The first order residual block in the reference layer may be computed between reconstructed pictures which are not up-sampled, thus are stored in memory at the spatial resolution of the reference layer.

The computation of the first order residual block in the reference layer then includes a down-sampling of the motion vector considered in the enhancement layer, towards the spatial resolution of the reference layer. The motion compensation is then performed at reduced resolution level in the reference layer, which provides a first order residual block predictor at reduced resolution.

Last inter-layer residual prediction step then consists in up-sampling the so-obtained first order residual block predictor, through a bilinear interpolation filtering for instance. Any spatial interpolation filtering could be considered at this step of the process (examples: 8-Tap DCTIF, 6-tap DCT-IF, 4-tap SVC filter, bilinear). This last embodiment may lead to slightly reduced coding efficiency in the overall scalable video coding process, but does not need additional reference picture storing compared to standard approaches that do not implement the present embodiment. Accordingly, a big saving of memory is achieved.

This corresponds to the following equation illustrated by FIG. 11:

PRED_{EL}=MC₁[REF_{EL},MV_{EL}]+{UPS(REC_{RL}−MC₄[REF_{RL},MV_{EL}/ratio])}

where MV_{EL}/ratio represents the motion vector in the enhancement layer downsampled by the ratio representing the difference in resolution between the enhancement layer and the reference layer.

Considering the current picture representation 1115 in the enhancement layer, the block 1108 of size H×W is obtained by motion compensation MC₁ of a block 1104 of size H×W of the reference EL picture representation REF_{EL} 1101 using the motion vector MV_{EL} 1106. The block 1109 of size h×w from a motion-compensated version of the reference RL picture representation 1113 is obtained by motion compensation MC₄ of a block 1105 of size h×w of the reference RL picture REF_{RL} 1102 using the downsampled motion vector MV_{EL} 1107. This block 1109 is subtracted to the RL block 1110 of size h×w of the RL current picture representation REC_{BL} 1103, collocated with the current EL coding block, to generate the RL residual block 1111 of size h×w. This RL residual block 1111 is then upsampled to obtain the upsampled residual block 1112 of size H×W. The upsampled residual block 1112 is finally added to the motion compensated block 1108 to generate the prediction PRED_{EL} 1114. In other words, the final enhancement layer prediction block 1114 corresponds to the predictor obtained by motion estimation in the enhancement layer, the block 1108, plus the upsampled residual obtained for the collocated block in the reference layer obtained with a downsampled version of the same motion vector.

It is worth noting that these three coding modes as illustrated by FIGS. 9, 10 and 11 share the same basic algorithm. First as motion compensation step is carried out in the enhancement layer. As a result, the location of a predictor block 906, 1007 and 1104, in the enhancement layer is determined associated with the corresponding motion vector 907 and 1106 in the enhancement layer. Next, a first predictor block 906, 1011, 1104 is determined. This first predictor is determined as the predictor block given by the motion compensation step in the enhancement layer for GRILP modes corresponding to FIGS. 9 and 11. This first predictor is determined as the block 1011 collocated to the coding block 1010 to be encoded in DIFF inter mode. Next, a prediction of the residue is carried out. The goal of this prediction of the residue is to determine a residual predictor block. This residual predictor block is determined as the subtraction of the block 910, 1105 collocated to the predictor 906, 1104 in the enhancement layer given by the motion compensation step to the block 912, 1110 collocated to the coding block 908, 1108 for the GRILP mode. This computation may be done at the enhancement layer resolution in FIG. 9, or at the reference layer resolution in FIG. 11. Next, a second predictor block is determined as the addition of this residual predictor block and the first predictor block. This second predictor block is used as the final predictor for the encoding.

It is important to note that additionally to the upsampling and motion compensation processes mentioned above, some filtering operations may be applied to the intermediate generated blocks. These filtering operations are aimed at reducing the compression artifacts coming from undesirable high frequency details. For instance, a filtering operator FILT_{X}, where x is an index related to the different types of filters that may be used, can be applied right after the motion compensation, or right after the upsampling or right after the second order residual prediction block generation. Some examples are provided in the following equations:

PRED_{EL}=MC₁[REF_{EL},MV_{EL}]+{UPS(REC_{RL})−FILT₁(MC₂[UPS(REF_{RL}),MV_{EL}])}

PRED_{EL}=UPS(REC_{RL})+FILT₁(MC₃[REF_{EL}−UPS(REF_{EL}),MV_{EL}])

PRED_{EL}=MC₁[REF_{EL},MV_{EL}]+FILT₁(UPS(REC_{RL}−MC₄[REF_{RL},MV_{EL}/ratio]))

PRED_{EL}=FILT₂(MC₁[REF_{EL},MV_{EL}])+{UPS(REC_{RL})−FILT₁(MC₂[UPS(REF_{RL}),MV_{EL}])}

PRED_{EL}=FILT₂(UPS(REC_{RL}))+FILT₁(MC₃[REF_{EL}−UPS(REF_{EL}),MV_{EL}])

PRED_{EL}=FILT₂(MC₁[REF_{EL},MV_{EL}])+FILT₁(UPS(REC_{RL}−MC₄[REF_{RL},MV_{EL}/ratio]))

The different processes involved in the prediction process, that is, upsampling, motion compensation, and possibly filtering, are achieved using linear filters applied using convolution operators.

The Base Mode prediction, used for encoding the base layer, may also use second order residual prediction. One way of implementing second order prediction in Base Mode consists in using the GRILP mode to generate the base layer motion compensation residue using the motion vector from the EL downsampled to the base layer resolution. This option avoids the storage of the decoded BL residue, since the BL residue can be computed on the fly from the EL motion vector. In addition this computed residue is guaranteed to fit the EL residue since the same motion vector is used for the EL and BL block. We can speak of ‘Base Mode á la GRILP’ for this type of Base Mode implementation.

The GRILP implementation as described in FIG. 9 or 11 involves two motion compensations in addition to the upsampling steps, which involves significant computation cost. In addition, GRILP has been described for uni-prediction, meaning for prediction using a single reference image. It can also apply in bi-prediction, meaning prediction using two reference images, involving therefore four motion compensations. Complexity is therefore even higher.

In DIFF inter mode as described in FIG. 10, there is only one motion compensation but additional buffers are required to store the second order residual signal, and then its motion compensated version, at the EL resolution. The potential additional filtering operator, in general, smoothing filter, can even increase the complexity and memory needs. The problem to be solved is therefore to reduce the computational complexity and the memory usage in the GRILP and DIFF Inter modes. The simplifications can also benefit to the base mode.

Beside the specific advantages of the solution, it is clear to the man skilled in the art that other usual advantageous design solutions can be applied to the provided means, such as making sure that the sum of the coefficients of a filter is a power of 2, which allows efficient hardware implementations.

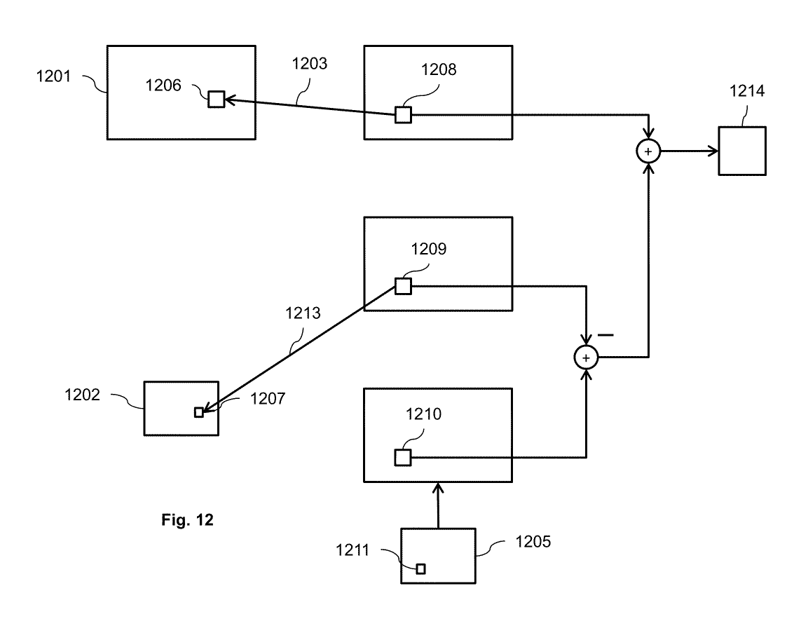

According to a particular embodiment, the operations of up or downsampling, motion compensation and/or filtering may be concatenated. This means that the operations involving a cascaded application of filters for interpolation or filtering purpose are replaced by the application of a single filter designed to carry out the cascading of contemplated operations. According to an embodiment, the single filter is designed as the convolution of the set of two elementary filters. In particular, the invention replaces MC₂ and UPS by the single cascaded filter MC₂∘UPS as described in the following equation illustrated on FIG. 12:

PRED_{EL}=MC₁[REF_{EL},MV_{EL}]+{UPS(REC_{RL})−MC₂∘UPS[REF_{RL},MV_{EL}/ratio]}

The block 1208 of size H×W is obtained by motion compensation MC₁ of a block 1206 of size H×W of the reference EL picture representation REF_{EL} 1201 using the motion vector MV_{EL} 1203. The block 1209 of size H×W is obtained by combining in one single step the motion compensation MC₂ and the upsampling of a block 1207 of size h×w of the reference RL picture REF_{RL} 1202 using the downsampled motion vector of MV_{EL} 1213. This block 1209 is subtracted to the RL block 1210 of size H×W, resulting from the upsampling of the RL block 1211 of size h×w from the RL current picture REC_{RL} 1205, collocated with the current EL block, to generate the RL residual block. This residual block is finally added to the motion compensated block 1208 to generate the prediction PRED_{EL} 1212 of size H×W.

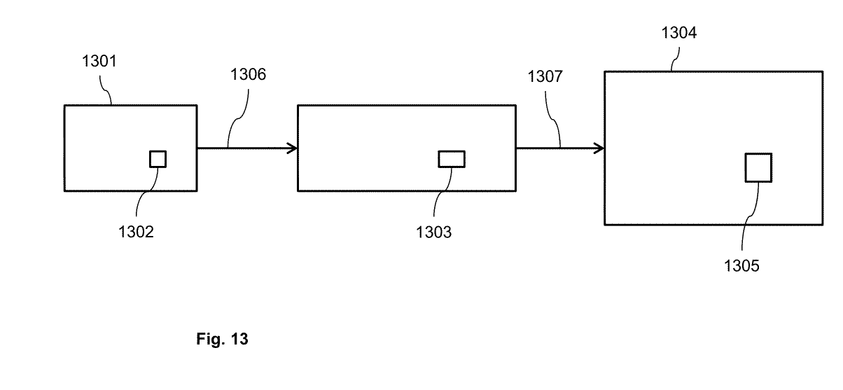

In a practical and simplified implementation, the linear filters are implemented separately for the horizontal and vertical dimensions. An embodiment of the invention is therefore to implement the concatenated upsampling and motion compensation step into two successive steps as described in FIG. 13. The block 1302 of size h×w, also corresponding to block 1207 in FIG. 12, from the RL reference picture REF_{RL} 1301, also corresponding to 1202 in FIG. 12, is first processed horizontally by the concatenated operator ‘MC₂∘UPS horizontal’ 1306 to generate the intermediate block 1303 of size h×W. This intermediate block 1303 is then processed by the concatenated operator ‘MC₂∘UPS vertical’ 1307 to generate the final block 1305 of size H×W, also corresponding to 1209 in FIG. 12. In general the ‘MC₂∘UPS horizontal’ and ‘MC₂∘UPS vertical’ involve the same linear filters coefficients. However in an embodiment, these filters coefficients may differ horizontally and vertically.

The operator MC₂∘UPS works as follows. For each integer position in the destination block, for example intermediate block 1303, or final block 1305, its corresponding position in the source block, for example block 1302 for the destination block 1303 or block 1303 for the destination block 1305, is defined according to the EL motion vector resampled to the RL resolution. This position p in the source block is defined with a given sub-pixel accuracy accur. For instance, if accuracy of motion vector is ⅛ pixel, accur=8 and the position p is defined by:

p=pᵢₙₜ+p_{sub}/accur

where pᵢₙₜ is the integer value of p, and p_{sub}/accur the fractional value. For each possible sub-pixel position p_{sub}, p_{sub} in {0 . . . accur−1}, also called phase, a linear filter is defined. So a set of polyphase filters is defined. The resulting sample in the destination block is then generated by convolving the source samples at the integer position pᵢₙₜ with the linear filter with phase p_{sub}.

If the motion vector in the EL MV_{EL} is of a given accuracy (e.g. ¼ th pixel), then the accuracy of the downsampled motion vector 1213 in FIG. 12 should be increased. For instance, in a dyadic spatial scalability, W=2w and H=2h, if the accuracy of the EL motion vector 1203 is of ¼ th pixel, the accuracy of the motion vector 1213 should be of ¼*½=⅛th pixel. In a spatial scalability where W=3/2.w and H=3/2.h, if the accuracy of the EL motion vector 1203 is of ¼th pixel, the accuracy of the motion vector 1213 should be of ¼*⅔=⅙th pixel.

In HEVC, when the chroma format is 4:2:0, the accuracy of luma motion vectors is ¼th pixel and the accuracy of chroma motion vectors is ⅛th pixel. So in case of dyadic spatial scalability, the downsampled motion vectors accuracy should be:
In dyadic spatial scalability (ratio 2×)
   ⅛th pixel from luma
   1/16th pixel from luma
In spatial scalability with inter-layer ratio of 3/2 (ratio 1.5×)
   ⅙th pixel from luma
   1/12th pixel from luma

It was indicated that a filtering operator can in addition be added, for the different possible implementations of GRILP and DIFF Inter modes. In an embodiment, the filtering operator is concatenated with the motion compensation and upsampling operators.

In a first example:

PRED_{EL}=MC₁[REF_{EL},MV_{EL}]+{UPS(REC_{RL})−FILT₁(MC₂[UPS(REF_{RL}),MV_{EL}])}

is replaced by

PRED_{EL}=MC₁[REF_{EL},MV_{EL}]+{UPS(REC_{RL})−FILT₁∘MC₂∘UPS[REF_{RL},MV_{EL}]}

where FILT₁∘MC₂∘UPS is a single operator concatenating the operators FILT₁, MC₂ and UPS.

In a second example:

PRED_{EL}=UPS(REC_{RL})+FILT₁(MC₃[REF_{EL}−UPS(REF_{EL}),MV_{EL}])

is replaced by

PRED_{EL}=UPS(REC_{RL})+FILT₁∘MC₃[REF_{EL}−UPS(REF_{EL}),MV_{EL}]

where FILT₁∘MC₃ is a single operator concatenating the operators FILT₁ and MC₃.

In a third example:

PRED_{EL}=MC₁[REF_{EL},MV_{EL}]+FILT₁(UPS(REC_{RL}−MC₄[REF_{EL},MV_{EL}/ratio]))

is replaced by

PRED_{EL}=MC₁[REF_{EL},MV_{EL}]+FILT₁∘UPS(REC_{RL}−MC₄[REF_{EL},MV_{EL}/ratio])

where FILT₁∘UPS is a single operator concatenating the operators FILT₁ and UPS.

In a fourth example:

PRED_{EL}=FILT₂(MC₁[REF_{EL},MV_{EL}])+{UPS(REC_{RL})−FILT₁(MC₂[UPS(REF_{RL}),MV_{EL}])}

is replaced by

PRED_{EL}=FILT₂∘MC₁[REF_{EL},MV_{EL}]+{UPS(REC_{RL})−FILT₁∘MC₂∘UPS[UREF_{RL},MV_{EL}]}

where FILT₂∘MC₁ is a single operator concatenating the operators FILT₂ and MC₁,

and FILT₁∘MC₂∘UPS is a single operator concatenating the operators FILT₁, MC₂ and UPS.

In a fifth example:

PRED_{EL}=FILT₂(UPS(REC_{RL}))+FILT₁(MC₃[REF_{EL}−UPS(REF_{EL}),MV_{EL}])

is replaced by

PRED_{EL}=FILT₂∘UPS(REC_{RL})+FILT₁∘MC₃[REF_{EL}−UPS(REF_{EL}),MV_{EL}]

where FILT₂∘UPS is a single operator concatenating the operators FILT₂ and UPS,

and FILT₁∘MC₃ is a single operator concatenating the operators FILT₁ and MC₃

In a sixth example:

PRED_{EL}=FILT₂(MC₁[REF_{EL},MV_{EL}])+FILT₁(UPS(REC_{RL}−MC₄[REF_{RL},MV_{EL}/ratio]))

is replaced by

PRED_{EL}=FILT₂∘MC₁[REF_{EL},MV_{EL}]+FILT₁∘UPS(REC_{RL}−MC₄[REF_{RL},MV_{EL}/ratio])

where FILT₂∘MC₁ is a single operator concatenating the operators FILT₂ and MC₁,

and FILT₁∘UPS is a single operator concatenating the operators FILT₁ and UPS.

Note that in an embodiment the results of the motion compensation operations MC₁ and MC₂, the results of the filtering operations FILT₁ and FILT₂, the results of then upsampling operation UPS and the results of the concatenation of these operations presented in the above formulas may be independently weighted by a weighting factor. For instance MC₁ becomes W_{MC1}·MC₁, FILT₁ becomes W_{FILT1}·FILT₁ and FILT₂∘MC₁ becomes W_{FILT2}∘_{MC1}(FILT₂∘MC₁).

In an embodiment of the invention, the proposed interpolation filters use 8 taps for luma and 4 taps for chroma, have total amplitude Amp of 64 and are defined, using the DCT-IF approach presented in document ITU-T SG16 WP3 and ISO/IEC JTC1/SC29/WG11 JCTVC-F247 “CE3: DCT derived interpolation filter test by Samsung”, as described in the following. In this embodiment, the filters corresponding to the combined operator MC∘UPS are directly derived for each sub-pixel position, also called phase, using the DCT-IF approach. The filters are therefore polyphase filters.

The interpolation filters used for luma with a ratio 2 are defined as follows:

| phase | −3 | −2 | −1 | 0 | 1 | 2 | 3 | 4 |
|---|---|---|---|---|---|---|---|---|
| 0/8 | 0 | 0 | 0 | 64 | 0 | 0 | 0 | 0 |
| 1/8 | 0 | 2 | −6 | 62 | 9 | −3 | 1 | 0 |
| 1/4 | −1 | 4 | −10 | 58 | 17 | −5 | 1 | 0 |
| 3/8 | −1 | 4 | −11 | 49 | 29 | −9 | 4 | −1 |
| 2/4 | −1 | 4 | −11 | 40 | 40 | −11 | 4 | −1 |
| 5/8 | −1 | 4 | −9 | 29 | 49 | −11 | 4 | −1 |
| 3/4 | 0 | 1 | −5 | 17 | 58 | −10 | 4 | −1 |
| 7/8 | 0 | 1 | −3 | 9 | 62 | −6 | 2 | 0 |

The interpolation filters used for chroma with a ratio 2 are defined as follows:

| phase | −1 | 0 | 1 | 2 |
|---|---|---|---|---|
| 0/16 | 0 | 64 | 0 | 0 |
| 1/16 | −2 | 63 | 3 | 0 |
| 2/16 | −2 | 58 | 10 | −2 |
| 3/16 | −4 | 58 | 11 | −1 |
| 4/16 | −4 | 54 | 16 | −2 |
| 5/16 | −4 | 50 | 21 | −2 |
| 6/16 | −6 | 46 | 28 | −4 |
| 7/16 | −4 | 41 | 31 | −3 |
| 8/16 | −4 | 36 | 36 | −4 |
| 9/16 | −3 | 31 | 41 | −4 |
| 10/16 | −4 | 28 | 46 | −6 |
| 11/16 | −2 | 21 | 50 | −4 |
| 12/16 | −2 | 16 | 54 | −4 |
| 13/16 | −1 | 11 | 58 | −4 |
| 14/16 | −2 | 10 | 58 | −2 |
| 15/16 | 0 | 3 | 63 | −2 |

The interpolation filters used for luma with a ratio 1.5 are defined as follows:

| phase | −3 | −2 | −1 | 0 | 1 | 2 | 3 | 4 |
|---|---|---|---|---|---|---|---|---|
| 0/6 | 0 | 0 | 0 | 64 | 0 | 0 | 0 | 0 |
| 1/6 | −1 | 3 | −7 | 61 | 12 | −4 | 2 | 0 |
| 2/6 | −1 | 4 | −11 | 52 | 26 | −8 | 3 | −1 |
| 2/4 | −1 | 4 | −11 | 40 | 40 | −11 | 4 | −1 |
| 4/6 | −1 | 3 | −8 | 26 | 52 | −11 | 4 | −1 |
| 5/6 | 0 | 2 | −4 | 12 | 61 | −7 | 3 | −1 |

The interpolation filters used for chroma with a ratio 1.5 are defined as follows:

| phase | −1 | 0 | 1 | 2 |
|---|---|---|---|---|
| 0/12 | 0 | 64 | 0 | 0 |
| 1/12 | −2 | 62 | 5 | −1 |
| 2/12 | −4 | 59 | 11 | −2 |
| 3/12 | −4 | 54 | 16 | −2 |
| 4/12 | −5 | 50 | 22 | −3 |
| 5/12 | −5 | 43 | 30 | −4 |
| 6/12 | −4 | 36 | 36 | −4 |
| 7/12 | −4 | 30 | 43 | −5 |
| 8/12 | −3 | 22 | 50 | −5 |
| 9/12 | −2 | 16 | 54 | −4 |
| 10/12 | −2 | 11 | 59 | −4 |
| 11/12 | −1 | 5 | 62 | −2 |

In these tables, the values in first line indicate the position shifting k to be applied in the convolution process. The well-known convolution operator to generate the filtered sample y from the input samples x can be approximated as the following equation:

$$y = ( {\sum }_{k = A}^{k = B} c [ {p}_{sub} ] [ k ] * x [ p + k ] ) / Amp$$

with A being the minimum position shifting, for example −3 for Interpolation filters Luma, −1 for Interpolation filters chroma, B being the maximum position shifting, for example 4 for Interpolation filters Luma, 2 for Interpolation filters chroma, and c[p_{sub}][k] for k=A . . . B being the filter coefficients of the filter of phase p_{sub}.

In an embodiment of the invention, the filters used for the operator MC₂∘UPS are directly obtained by solving a set of linear equations for each given phase. For a Map filter, of phase ph, the following equations are solved:

c[−N/2+1]*(x−N/2+1)^{k}+c[−N/2+2]*(x−N/2+2)^{k}+ . . . +c[N/2]*(x+N/2)^{k}=(x−ph)^{k}

for k=0, . . . , N−1 and for any integer x.

The resulting coefficients c[k], k=0, . . . , N−1 are the resulting filter of phase ph.

In an embodiment of the invention, the filters used for the operator MC₂∘UPS are obtained by convolving the filters of the operator UPS with the filters of the operator MC₂.

The convolved filter can be derived as follows. Let the current sample to be predicted in the EL picture be at position p. It is predicted from the upsampled RL by displacing the position by d, d being with accuracy a (for instance a=4 for ¼th pixel accuracy). The displaced pixel p is positioned in pixel q in the upsampled RL, with:

q=p+d=pi+ps/a

pi being an integer position and ps being the fractional position in the RL, belonging to the set {0, . . . , a−1}. Let m[k][l] be the normalized coefficient l of the motion compensation filter with phase k. Let y[k] for any k be the upsampled RL signal. The displaced EL signal z[p] at position p is computed as:

$$z ( p ) = {\sum }_{k = A}^{B} m [ ps ] [ k ] * y [ pi + k ]$$

The pixel pi in the upsampled RL is located at the position r in the non-upsampled RL:

r=ri+rs/b

ri being an integer position and rs being the fractional position belonging to the set {0, . . . , b−1}, where b is the number of phases required (for instance, for an inter-layer spatial ratio of 2, b=2; for an inter-layer spatial ratio of 3/2, b=3). Let u[k][l] be the normalized coefficient/of the upsampling filter with phase k, l being defined from C to D, the minimum and maximum position shifting of the filter (number of taps is D−C+1). Let x[k] be the non-upsampled RL signal. The displaced EL signal z[p] at position p can be expressed as:

$$z ( p ) = {\sum }_{n = - rs}^{b - 1 - rs} \{ m [ ps ] [ n ] * {\sum }_{l = C}^{D} u [ rs + n ] [ l ] * x [ ri + l ] \} + {\sum }_{n = b - rs}^{2 b - 1 - rs} \{ m [ ps ] [ n ] * {\sum }_{l = C}^{D} u [ rs + n - b ] [ l ] * x [ ri + 1 + l ] \} + {\sum }_{n = 2 b - rs}^{3 b - 1 - rs} \{ m [ ps ] [ n ] * {\sum }_{l = C}^{D} u [ rs + n - 2 b ] [ l ] * x [ ri + 2 + l ] \} + {\sum }_{n = - b - rs}^{- 1 - rs} \{ m [ ps ] [ n ] * {\sum }_{l = C}^{D} u [ b + rs + n ] [ l ] * x [ ri - 1 + l ] \} + {\sum }_{n = - 2 b - rs}^{- b - 1 - rs} \{ n [ ps ] [ n ] * {\sum }_{l = C}^{D} u [ 2 b + rs + n ] [ l ] * x [ ri - 2 + l ] \} + ⋮$$

which can be rewritten as:

$$z ( p ) = {\sum }_{n = - rs}^{b - 1 - rs} \{ m [ ps ] [ n ] * {\sum }_{l = c}^{D} u [ rs + n ] [ l ] * x [ ri + l ] \} + {\sum }_{n = b - rs}^{2 b - 1 - rs} \{ m [ ps ] [ n ] * {\sum }_{l = C + 1}^{D + 1} u [ rs + n - b ] [ l - 1 ] * x [ ri + 1 ] \} + {\sum }_{n = 2 b - rs}^{3 b - 1 - rs} \{ [ ps ] [ n ] {\sum }_{l = C + 2}^{D + 2} u [ rs + n - 2 b ] [ l - 2 ] * x [ ri + l ] \} + ⋮ {\sum }_{n = - b - rs}^{- 1 - rs} \{ m [ ps ] [ n ] * {\sum }_{l = C - 1}^{D - 1} u [ b + rs + n ] [ l + 1 ] * x [ ri + l ] \} + {\sum }_{n = - 2 b - rs}^{- b - 1 - rs} \{ m [ ps ] [ n ] * {\sum }_{l = C - 2}^{D - 2} u [ 2 b + rs + n ] [ l + 2 ] * x [ ri + l ] \} + ⋮$$

By grouping all terms related to x[ri+l], it can be deduced that for the position l, the convolved filter coefficient c[l] is equal to:

$$c [ l ] = {\sum }_{n = - rs}^{b - 1 - rs} m [ ps ] [ n ] * u [ rs + n ] [ l ] + {\sum }_{n = b - rs}^{2 b - 1 - rs} m [ ps ] [ n ] * u [ rs + n - b ] [ l - 1 ] + {\sum }_{n = 2 b - rs}^{3 b - 1 - rs} m [ ps ] [ n ] * u [ rs + n - 2 b ] [ l - 2 ] + ⋮ {\sum }_{n = - b - rs}^{- 1 - rs} m [ ps ] [ n ] * u [ rs + n + b ] [ l + 1 ] + {\sum }_{n = - 2 b - rs}^{- b - 1 - rs} [ ps ] [ n ] * u [ 2 b + rs + n ] [ l + 2 ] + ⋮$$

where it is considered that m[g][h]=0 if h<A or h>B, and similarly u[g][h]=0 if h<C or h>D.

As an example, if we just consider the ratio 2, with the 8-tap upsampling filter derived from the DCT-IF approach, defined as follows (filter amplitude is 64 in this example):

| phase | −3 | −2 | −1 | 0 | 1 | 2 | 3 | 4 |
|---|---|---|---|---|---|---|---|---|
| 0/4 | 0 | 0 | 0 | 64 | 0 | 0 | 0 | 0 |
| 1/4 | −1 | 4 | −10 | 58 | 17 | −5 | 1 | 0 |
| 2/4 | −1 | 4 | −11 | 40 | 40 | −11 | 4 | −1 |
| 3/4 | 0 | 1 | −5 | 17 | 58 | −10 | 4 | −1 |

and the motion compensation filter being a 2-tap bilinear filter (filter amplitude is 2 in this example):

| phase | 0 | 1 |
|---|---|---|
| 0/2 | 2 | 0 |
| 1/2 | 1 | 1 |

the resulting filters for all the intermediate ⅛ phases (⅛, ⅜, ⅝, ⅞) are derived by averaging the two filters with nearest ¼ phases. This is shown in the following table, where the bold font indicates the generated convolved filters (filter amplitude is 64 in this example):

| phase | −3 | −2 | −1 | 0 | 1 | 2 | 3 | 4 |
|---|---|---|---|---|---|---|---|---|
| 0/8 | 0 | 0 | 0 | 64 | 0 | 0 | 0 | 0 |
| 1/8 | −1 | 2 | −5 | 55 | 8 | −3 | 0 | 0 |
| 1/4 | −1 | 4 | −10 | 58 | 17 | −5 | 1 | 0 |
| 3/8 | −1 | 4 | −11 | 49 | 28 | −8 | 2 | −1 |
| 2/4 | −1 | 4 | −11 | 40 | 40 | −11 | 4 | −1 |
| 5/8 | −1 | 2 | −8 | 28 | 49 | −11 | 4 | −1 |
| 3/4 | 0 | 1 | −5 | 17 | 58 | −10 | 4 | −1 |
| 7/8 | 0 | 0 | −3 | 8 | 55 | −5 | 2 | −1 |

For the ¼ phases, the normal DCT-IF filters are used.

If an additional linear filter FILT is introduced in the process, the cascading of motion compensation, upsampling and filtering processes (in any order) can be concatenated into one single linear filter by convolving the filters from these three processes. The convolved filters principle can also apply for any of the previously mentioned processes: FILT₁∘MC₂∘UPS, FILT₁∘MC₃, FILT₁∘UPS, FILT₂∘MC₁, FILT₁∘MC₂∘UPS.

An example of such a linear filter could for instance be a lowpass filter, e.g. [1 14 1]/16. In the case that the MC filter is a bilinear one as the one described in the foregoing, the new concatenated filter FILT∘MC is for luma with a ratio 2:

| phase | −1 | 0 | 1 | 2 |
|---|---|---|---|---|
| 0/8 | 4 | 56 | 4 | 0 |
| 1/8 | 3 | 50 | 11 | 0 |
| 1/4 | 3 | 43 | 17 | 1 |
| 3/8 | 2 | 37 | 24 | 1 |
| 2/4 | 2 | 30 | 30 | 2 |
| 5/8 | 1 | 24 | 37 | 2 |
| 3/4 | 1 | 17 | 43 | 3 |
| 7/8 | 0 | 11 | 50 | 3 |

For complexity reasons, it is often preferable to limit the size of the filters. This is true for any of the linear filtering processes involved in GRILP or DIFF Inter modes. In particular the limitation of the Upsampling (UPS) filters size, Motion Compensation (MC₁ or MC₂) filters size, or Concatenated Upsampling and Motion Compensation (MC∘UPS) filters size, is beneficial in terms of complexity. It has been observed that such limitations can even bring coding gains.

In an embodiment, given a linear filter g[k], k=A_{g} . . . B_{g}, an attenuation filter w[k], such as a Hamming window, a Tukey window or a Cosine Window, may be applied to the filter coefficients:

g′[k]=w[k]g[k]

where w [k]=0 for k<A′ and k>B′, with A′>=A_{g} and B′<=B_{g}.

In particular, to limit the size of the Convolved Upsampling and Motion Compensation filter f_{U∘M}[p_{sub}][m], the attenuation window can have A′<=Max(A_{U}, A_{M}) and B′<=Min(B_{U}, B_{M}), so that the resulting filter is not of larger size than any of the Upsampling or Motion Compensation filters.

In an embodiment of the invention, the proposed interpolation filters of the Concatenated Upsampling and Motion Compensation are bilinear filters, using 2 taps for luma and/or for chroma:

f_{U∘M}[0]=Amp*(1−1/p_{sub})

f_{U∘M}[1]=Amp*(1/p_{sub})

For instance, the following filters of amplitude Amp=64 can be specified for the Interpolation filters of Luma for spatial ratio 2:

| phase | 0 | 1 |
|---|---|---|
| 0/8 | 64 | 0 |
| 1/8 | 56 | 8 |
| 1/4 | 48 | 16 |
| 3/8 | 40 | 24 |
| 2/4 | 32 | 32 |
| 5/8 | 24 | 40 |
| 3/4 | 16 | 48 |
| 7/8 | 8 | 56 |

In an embodiment of the invention, the interpolation filters for the processes MC₁ and MC₂ or MC₃ are bilinear filters, using 2 taps for luma and/or for chroma. In an embodiment of the invention, the interpolation filters for the process of Upsampling UPS are bilinear filters, using 2 taps for luma and/or for chroma.

In an embodiment of the invention, the accuracy of the downsampled motion vector is more limited than what should be theoretically used given the EL motion vectors accuracy and the spatial scalability ratio. For instance, for the spatial scalability ratio 1.5, accuracy of ¼th pixel for luma and of ⅛th pixel for chroma can be used instead of the theoretical ⅙th pixel for luma and of 1/12th pixel for chroma. The downsampled EL motion vector is rounded to the closest value corresponding to the authorized accuracy. Another example is, for ratio 2, to limit the luma downsampled EL motion vector accuracy to ¼th pixel instead of ⅛th pixel and the chroma downsampled EL motion vector accuracy to ⅛th pixel instead of 1/16th pixel.

Accordingly it is possible to reuse the buffer of RL which is already needed for reference frame, which results in memory saving. A lower total complexity than ‘ordinary’ GRILP is achieved, since the linear filtering steps can be noticeably simplified. A potential gain in coding efficiency is also achieved. It has been indeed observed that using shorter filters may give an improved performance of the GRILP mode. This is mainly due to the smoothing effect of short filters such as bilinear filters, which reduce the coding artifacts possibly present in the BL prediction residual signal. These simplifications are also applicable to the ‘Base Mode á la GRILP’, when the Base Mode is implemented using the second order prediction approach of GRILP or DIFF Inter.

At the encoding side, there is a search process consisting in evaluating the different coding modes, and for inter coding modes, performing a motion search to find the best motion vectors for each inter mode. In particular, for the GRILP or DIFF Inter modes, a motion search may apply. Once the best mode is chosen, the final coding process applies for this best mode. In an embodiment of the invention, at the encoding side, it is proposed for the GRILP or Inter Diff Inter modes evaluation to perform the upsampling and motion compensation steps of the RL reference pictures in two separate steps to generate the prediction signal. Then, if GRILP or DIFF Inter mode is chosen as the best mode, the final prediction signal is generated using the concatenated upsampling and motion compensation process. In some implementations, this solution may reduce the encoding time while keeping the advantage at the decoder side of a reduced memory need.

The GRILP or DIFF Inter modes are computation intensive modes when compared to other known Inter prediction modes. When considering using these modes for Bi-Predictive coding blocks, the complexity may become a real issue. It is known that Bi-blocks are an important burden in many encoders and decoders implementations. This issue also exists in the Base Mode when it uses 2^{nd} order residual prediction, such as in the ‘Base Mode á la GRILP’.

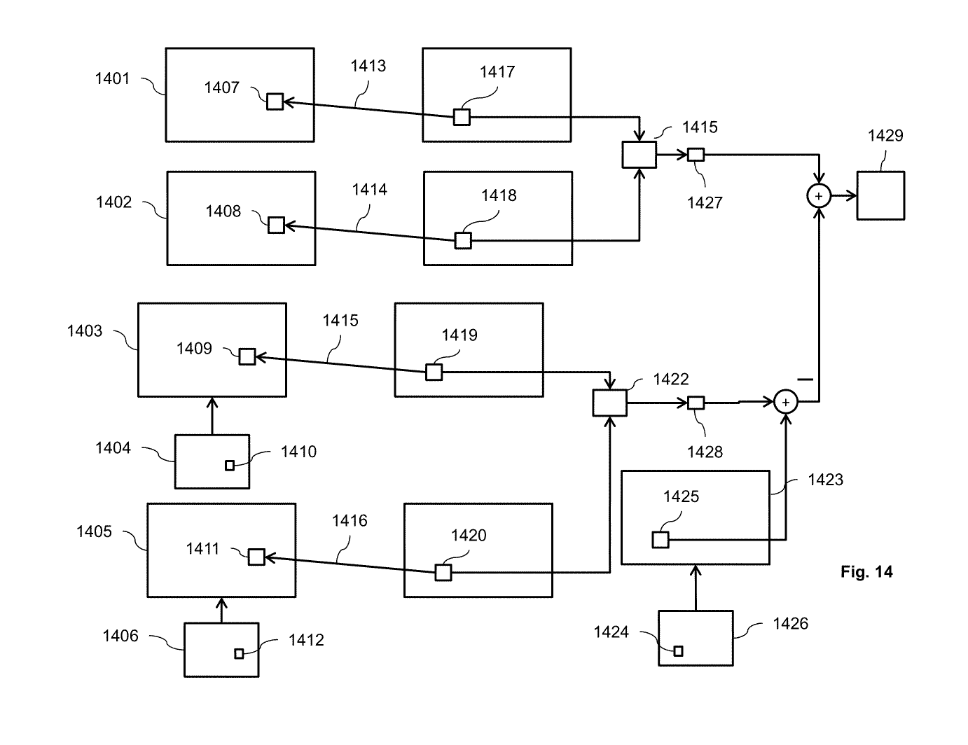

FIG. 14 illustrates GRILP in a Bi-Predictive case. Two EL motion vectors 1413 and 1414 are used. Similarly, two RL motion vectors 1415, corresponding to EL motion vector 1413 possibly downsampled, and 1416, corresponding to EL motion vector 1414 possibly downsampled, are also used. The EL motion compensated block 1417 is obtained by motion compensation of the EL block 1407 from the first EL reference picture 1401 using the EL motion vector 1413. The EL motion compensated block 1418 is obtained by motion compensation of the EL block 1408 from the second EL reference picture 1402 using the EL motion vector 1414. These two blocks are then mixed in step 1421 to generate the EL Bi-Predictive block 1427. Regarding the RL motion compensation, the following applies. The RL motion compensated block 1419 is obtained by motion compensation of upsampled RL block 1409 from the first upsampled B reference picture 1403 using the motion vector 1415, same as motion vector 1413. This upsampled RL block 1409 is obtained by upsampling the RL block 1410 from the first RL reference picture 1404. The RL motion compensated block 1420 is obtained by motion compensation of upsampled RL block 1411 from the first upsampled B reference picture 1405 using the motion vector 1416, same as motion vector 1414. This upsampled RL block 1411 is obtained by upsampling the RL block 1412 from the second RL reference picture 1406. Block 1419 and 1420 are then mixed in step 1422 to generate the upsampled RL Bi-Predictive block 1428. This upsampled RL Bi-Predictive block 1428 is subtracted to the current upsampled RL block 1425, resulting from the upsampling of the RL block 1426 from the RL picture 1424. The resulting 2^{nd} order residual block is added to the EL Bi-Predictive block 1427 to generate the final prediction block 1429.

In an embodiment of the invention it is proposed to use the mode GRILP or DIFF Inter conditionally for Bi-Predictive blocks. When considering a Bi-Predictive block, a condition is checked to verify whether the mode may apply to the block or not.

In an embodiment, this restriction only applies at the encoder side. The mode used is then indicated by signaling in the encoded signal.

In an embodiment, this restriction applies both at the encoder side and decoder side, with syntax and entropy coding modifications in order to avoid useless signaling relative to Bi-Prediction when the condition is verified and that the restriction for the mode GRILP or DIFF Inter applies. In particular, if the restriction consists in forbidding the mode for Bi-Predictive blocks, the coding of the flag signaling the usage of the mode can be removed for such blocks. Its value is inferred. Another example is the addition of context-adaptive binary arithmetic coding (CABAC) contexts related to the condition: the context value depends on the condition checking result.

In an embodiment, the mode GRILP or DIFF Inter is never allowed for blocks subject to bi-predictive encoding.

In an embodiment, the restriction for the mode GRILP or DIFF Inter consists in limiting the accuracy of the motion compensation, for the EL motion compensation, or for the RL motion compensation, or for both. For instance, when an EL block is Bi-Predictive with GRILP activated, the EL and RL motion vectors are limited to integer-pixel accuracy. Another example is to limit the EL motion vectors accuracy to integer-pixel, and the RL motion vectors accuracy to ½ pixel. Another example is to use motion compensation filters with fewer taps, thereby reducing the number of computations.

In an embodiment, the condition to enable or disable the GRILP or DIFF Inter mode for Bi-Predictive blocks is based on the checking of information pertaining to the reference picture, for instance its reference picture index ref_idx or the quantization parameter. This may be advantageous because the residual obtained through GRILP-like operations may be of lower quality with higher quantization parameter values, or as temporal distance increases.

In an embodiment, the restriction applies only to blocks of dimensions specified in a given range. For instance, the restriction applies to blocks sized 4×4 and 8×8, while for larger blocks no limitation is set.

In an embodiment, when bi-predictive prediction should be applied to a block, a single motion vector and thus a single prediction may instead be generated. This may be worthwhile for the merge mode where motion is inherited from spatial neighbors and thus may be forced to use two motion vectors. This embodiment will be described in more details below.

In an embodiment, the restriction on the GRILP usage depends on the block size of the co-located RL block. In the current HEVC specification, motion compensation cannot be applied on blocks smaller than 8×8. In this embodiment, it is therefore imposed that if GRILP mode involves, in the reference layer, processes comprising motion compensation applied to blocks smaller than a given size, then GRILP mode is not authorized. For instance, using the GRILP implementations of FIG. 11 or 12, if the blocks 1110 or 1211 are smaller than 8×8 pixels, then GRILP mode is not enabled. This restriction may also apply for the Base Mode á la GRILP.

The previous restrictions regarding Bi-Prediction case can apply to the Base Mode.

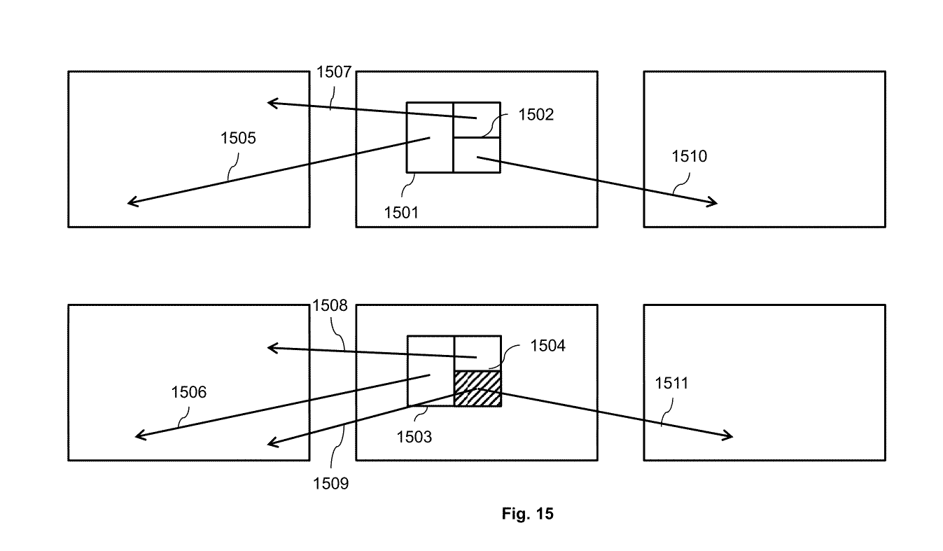

In an embodiment, in the Base Mode case in which the used motion vector for the EL is inherited from the RL motion vector, for EL parts of the EL block coded as Base Mode block, having co-located RL Bi-Predictive blocks, no second order prediction applies for these EL parts. For instance, in FIG. 15, an EL block 1501 and its corresponding upsampled RL block 1503 are represented. In the upsampled RL block 1503, a sub-block 1504 is coded as Bi-Predictive block, illustrated by the dashed block, while the other parts of the upsampled RL block 1503 are not coded with Bi-Prediction. The corresponding EL part 1502 of the EL block 1501 is therefore coded without second order prediction, while the other parts of the EL block 1501 are using second order prediction.

In another embodiment, in the Base Mode case, no second order prediction is used for the entire EL block coded as a Base Mode block as soon as at least one of the co-located RL blocks is coded as a Bi-Predictive block. In the example of FIG. 15, this means that the entire EL block 1501 does not use second order prediction, since in the co-located RL block 1503, there is a sub-block 1504 that uses Bi-Prediction.

In an embodiment, in the Base Mode case, for the EL parts of the EL block coded as Base Mode block, having co-located RL Bi-Predictive blocks, Uni-Prediction applies to these EL parts, or to the corresponding co-located RL Bi-Predictive blocks, or to both. In an embodiment, Uni-Prediction uses one of the two or more motion vectors from the co-located RL Bi-Predictive blocks. In an embodiment, the motion vector used for the Uni-Prediction is the one among the two or more that refers to the temporally closest reference picture to the current picture. In an embodiment, the respective quantization parameters of the reference pictures are also considered. In an embodiment, the motion vector used for the Uni-Prediction is a combination of the two or more motion vectors. Referring to the example of FIG. 15, the EL part 1502 of the EL block 1501 having as co-located RL block the Bi-Predictive block 1504 only uses one of the two motion vectors 1509 and 1511 of the block. The motion vector 1510 used for this EL block 1502 is actually in this example the upsampled version of the RL motion vector 1511. In another embodiment, the selected motion vector is determined by a syntax element of higher-level, such a flag in the slice header or picture parameter set.

In previous embodiments we have shown that the complexity of the DIFF inter mode and the GRILP mode could be efficiently reduced by the use of bilinear filters during the motion compensation. l one embodiment, a similar complexity reduction effect could be obtained for the base mode prediction mode, by employing bilinear filters during the interpolation process applied to the base mode image during the motion compensation performed for the base mode prediction mode.

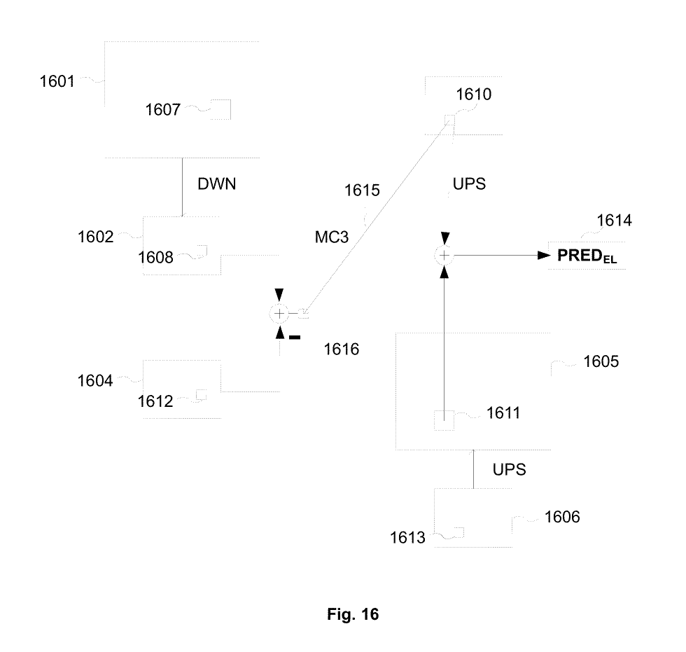

In another embodiment of the invention, a further reduction complexity of the DIFF inter mode is proposed. In this embodiment when generating the residual block, instead of performing the motion compensation step at the enhancement layer resolution, the motion compensation step is performed at the base layer resolution, as shown in FIG. 16. A residual block 1616 is computed as the difference between the reference BL block 1612 from the reference BL picture 1604, and the downsampled EL reference block 1608 from the reference downsampled EL picture 1602, both identified from the motion vector 1615. This downsampled EL reference block 1608 is obtained by downsampling the reference EL block 1607 from the reference EL picture 1601. Then motion compensation applies to the residual block 1616, at the BL resolution, using the downsampled motion vector 1615 to obtain the motion compensation BL residual block 1610. The BL residual block 1610 is upsampled and added to the upsampled BL block 1611 to give the prediction block 1614.

In an embodiment of the invention, in the DIFF inter mode, the steps of motion compensation and downsampling to generate the BL block 1608 are concatenated into one single step.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method for encoding an image of pixels according to a scalable encoding scheme having an enhancement layer and a reference layer, the method comprising for the encoding of a coding block in the enhancement layer in a coding mode called GRILP or DIFF inter:
(a) determining a predictor of said coding block in the enhancement layer and the associated motion vector by a motion compensation step;
(b) determining a first predictor block of the coding block;
(c) determining a residual predictor block based on said motion compensation step and the reference layer;
(d) determining a second predictor block by adding the first predictor block and said residual predictor block;
(e) predictive encoding of the coding block using said second predictor block;
wherein at least one of the steps (a) to (e) involving an application of a single concatenated filter for cascading successive elementary filtering processes related to block processing including motion compensation and/or block upsampling and/or block filtering.

2. A method according to claim 1, wherein the determined first predictor block of the coding block is the determined predictor of said coding block in the enhancement layer.

3. A method according to claim 1, wherein the determined first predictor block of the coding block is the block in the reference layer co-located to said coding block.

4. A method according to claim 1, wherein the single concatenated filter is based on the convolution of at least two elementary filters, each elementary filter corresponding to an elementary mathematical operator.

5. A method according to claim 4, wherein the at least two elementary mathematical operators are the upsampling process of the reference base layer picture resulting in the upsampled reference base layer picture, and the motion compensation process of the upsampled reference base layer picture.

6. A method according to claim 1, wherein the single concatenated filter is based on a pre-determined interpolation filter derived from a Discrete Cosine Transform.

7. A method according to claim 1, wherein the single concatenated filter is based on a pre-determined interpolation filter derived from the resolution of linear equations systems function of the phases.

8. A method according to claim 6, wherein an image comprising at least two colour components, the pre-determined interpolation filter comprises specific values to be applied to each colour component.

9. A method according to claim 1, wherein said concatenated filter is further convolved by an attenuation window in order to reduce the filter size.

10. A method according to claim 1, wherein the method further comprises:
forbidding the GRILP encoding mode and the DIFF inter encoding mode for coding block subject to bi-predictive encoding.

11. A method for encoding an image of pixels according to a scalable encoding scheme having an enhancement layer and a reference layer, the method comprising for the encoding of a coding block in the enhancement layer in a coding mode called GRILP or DIFF inter:
(a) determining a predictor of said coding block in the enhancement layer and the associated motion vector by a motion compensation step;
(b) determining a first predictor block of the coding block;
(c) determining a residual predictor block based on said motion compensation step and the reference layer;
(d) determining a second predictor block by adding the first predictor block and said residual predictor block;
(e) predictive encoding of the coding block using said second predictor block; and wherein the method further comprises:
(f) forbidding the GRILP encoding mode and the DIFF inter encoding mode, or enabling the GRILP encoding mode or the DIFF inter encoding mode based on information pertaining to the reference picture, or enabling the GRILP encoding mode or the DIFF inter encoding mode based on the size of the coding block, or enabling the GRILP encoding mode or the DIFF inter encoding mode based on the size of the block in the reference layer collocated to the coding block, or disabling the GRILP encoding mode or the DIFF inter encoding mode for coding block when at least one of the collocated block in the reference layer is subject to bi-predictive encoding, for coding block subject to bi-predictive encoding.

12. A method according to claim 1, wherein the method further comprises:
limiting the accuracy of the motion compensation step for coding blocks subject to bi-predictive encoding.

13. A method according to claim 1, wherein the method further comprises:
limiting the filter size used in the motion compensation step for coding blocks subject to bi-predictive encoding.

14. A method for decoding a bit stream comprising data representing an image encoded according to a scalable encoding scheme having an enhancement layer and a reference layer, the method comprising for the decoding of said enhancement layer:
(a) obtaining from the bit stream the motion vector associated to a prediction of a coding block within the enhancement layer to be decoded and a residual block;
(b) determining a residual predictor block based on said location and the reference layer;
(c) determining a first predictor block of the coding block;
(d) determining a second predictor block by adding the first predictor block and said residual predictor block;
(e) reconstructing the coding unit using the second predictor block and the obtained residual block;
wherein at least one of the steps (b) to (e) involving an application of a single concatenated filter for cascading successive elementary filtering processes related to block processing including motion compensation and/or block upsampling and/or block filtering.

15. A method according to claim 14, wherein the determined first predictor block of the coding block is the predictor block associated with the obtained motion vector in the enhancement layer.

16. A method according to claim 14, wherein the determined first predictor block of the coding block is the block in the reference layer co-located to said coding block.

17. A method according to claim 14, wherein the single concatenated filter is based on the convolution of at least two elementary filters, each elementary filter corresponding to an elementary mathematical operator.

18. A method according to claim 17, where the at least two elementary mathematical operators are the upsampling process of the reference base layer picture resulting in the upsampled reference base layer picture, and the motion compensation process of the upsampled reference base layer picture.

19. A method according to claim 14, wherein the single concatenated filter is based on a pre-determined interpolation filter derived from a Discrete Cosine Transform.

20. A method according to claim 14, wherein the single concatenated filter is based on a pre-determined interpolation filter derived from the resolution of linear equations systems based dependent on the phases of the filter.

21. A method according to claim 19, wherein an image comprising at least two colour components, the pre-determined interpolation filter comprises specific values to be applied to each colour component.

22. A method according to claim 14, wherein said concatenated filter is further convolved by an attenuation window in order to reduce the filter size.

23. A method according to claim 14, wherein the motion vector obtained in the enhancement layer being determined according to a given accuracy, the method further comprises:
down sampling said motion vector to be used in the reference layer with an accuracy lower than the accuracy theoretically given based on the given accuracy and the spatial scalability ratio between the reference layer and the enhancement layer.

24. A method according to claim 14, wherein the method further comprises:
limiting the accuracy of the motion compensation step for decoding blocks subject to bi-predictive encoding.

25. A method according to claim 14, wherein the method further comprises:
limiting the filter size used in the motion compensation step for decoding blocks subject to bi-predictive encoding.

26. A method for encoding or decoding an image of pixels according to a scalable format having an enhancement layer and a reference layer, the method comprising for the encoding or the decoding of a coding block in the enhancement layer:
(a) determining a first predictor of said coding block in the enhancement layer using an associated motion vector;
(b) determining a second predictor block co-located to the first predictor block in the base layer;
(c) determining a residual predictor block as the difference between the first and the second predictor block;
(d) motion compensating the residual predictor block using the associated motion vector;
(e) obtaining a third predictor block by adding the motion compensated residual block to the block of the base layer co-located to the coding block
(f) predicting the coding block using said third predictor block;
Wherein the first predictor is down-sampled to the resolution of the base layer before the determination of the residual predictor block.

27. A method according to claim 26 wherein the associated motion vector is down-sampled to the base layer resolution before motion compensating the residual predictor block

28. A method according to claim 26 where the third predictor block is up-sampled to the resolution of the enhancement layer before the predicting step.

29. A device for encoding an image of pixels according to a scalable encoding scheme having an enhancement layer and a reference layer, the device comprising for the encoding of a coding block in the enhancement layer in a coding mode called GRILP or DIFF inter:
(a) means for determining a predictor of said coding block in the enhancement layer and the associated motion vector by a motion compensation step;
(b) means for determining a first predictor block of the coding block;
(c) means for determining a residual predictor block based on said motion compensation step and the reference layer;
(d) means for determining a second predictor block by adding the first predictor block and said residual predictor block;
(e) means for predictive encoding of the coding block using said second predictor block; and wherein the device further comprises:
(f) means for forbidding the GRILP encoding mode and the DIFF inter encoding mode, or enabling the GRILP encoding mode or the DIFF inter encoding mode based on information pertaining to the reference picture, or enabling the GRILP encoding mode or the DIFF inter encoding mode based on the size of the coding block, or enabling the GRILP encoding mode or the DIFF inter encoding mode based on the size of the block in the reference layer collocated to the coding block, or disabling the GRILP encoding mode or the DIFF inter encoding mode for coding block when at least one of the collocated block in the reference layer is subject to bi-predictive encoding, for coding block subject to bi-predictive encoding.

30. A device for decoding a bit stream comprising data representing an image encoded according to a scalable encoding scheme having an enhancement layer and a reference layer, the device comprising for the decoding of said enhancement layer:
(a) means for obtaining from the bit stream the motion vector associated to a prediction of a coding block within the enhancement layer to be decoded and a residual block;
(b) means for determining a residual predictor block based on said location and the reference layer;
(c) means for determining a first predictor block of the coding block;
(d) means for determining a second predictor block by adding the first predictor block and said residual predictor block;
(e) means for reconstructing the coding unit using the second predictor block and the obtained residual block;
wherein at least one of the means (b) to (e) is configured for an application of a single concatenated filter for cascading successive elementary filtering processes related to block processing including motion compensation and/or block upsampling and/or block filtering.

31. A device for encoding or decoding an image of pixels according to a scalable format having an enhancement layer and a reference layer, the device comprising for the encoding or the decoding of a coding block in the enhancement layer:
(a) a means for determining a first predictor of said coding block in the enhancement layer using an associated motion vector;
(b) a means for determining a second predictor block co-located to the first predictor block in the base layer;
(c) a means for determining a residual predictor block as the difference between the first and the second predictor block;
(d) a means for motion compensating the residual predictor block using the associated motion vector;
(e) a means for obtaining a third predictor block by adding the motion compensated residual block to the block of the base layer co-located to the coding block
(e) a means for predicting the coding block using said third predictor block;
Wherein the device comprises a means for down-sampling the first predictor to the resolution of the base layer before the determination of the residual predictor block.

32. A device according to claim 31 wherein the associated motion vector is down-sampled to the base layer resolution before motion compensating the residual predictor block

33. A device according to claim 31 where the third predictor block is up-sampled to the resolution of the enhancement layer before the predicting step.

34. A computer-readable storage medium storing instructions of a computer program for implementing a method according claim 1.
